(19) United States
(12) Patent Application Publication
(10) Pub. No.: US 2004/0073449 A1
(43) Pub. Date: Apr. 15, 2004

(54) Catering mobile pick up station

(76) Inventor: Ping Yang, Chino Hills, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/681,685

(22) Filed: Oct. 8, 2003

Related U.S. Application Data
(63) Continuation-in-part of application No. 10/055,144, filed on Jan. 22, 2002.
Application No. 10/055,144 is a continuation-in-part of application No. 09/733,873, filed on Dec. 8, 2000.
(60) Provisional application No. 60/263,530, filed on Jan. 22, 2001.
(60) Provisional application No. 60/301,761, filed on Jun. 28, 2001.
(60) Provisional application No. 60/453,053, filed on Mar. 8, 2003.
(60) Provisional application No. 60/453,664, filed on Mar. 11, 2003.
(60) Provisional application No. 60/458,156, filed on Mar. 27, 2003.
(60) Provisional application No. 60/465,314, filed on Apr. 25, 2003.
(60) Provisional application No. 60/472,310, filed on May 21, 2003.
(60) Provisional application No. 60/483,783, filed on Jun. 28, 2003.

(51) Int. Cl. G06F 17/60

(52) U.S. Cl. 705/1; 701/202

(57) ABSTRACT

A method and system for scheduling delivery and delivery of products to buyers. A Mobile Pickup Station (MPS) server is placed within a computer network and receives product shipping instructions from buyers or third party sellers. The MPS server determines optimal pickup points using buyer commuting information and buyer delivery requests. A portable kiosk or locker station, enclosing buyers' purchases within individually lockable lockers, is placed at a pickup point chosen by the buyers. The buyers use access codes, such as a product ID and password, to unlock the lockers and receive their purchases.

### CROSS-REFERENCE TO RELATED APPLICATIONS

This application is a continuation-in-part of U.S. patent application Ser. No. 10/055,144 filed Jan. 22, 2002, which is a continuation-in-part of U.S. patent application Ser. No. 09/733,873 filed Dec. 8, 2000 and claims the benefit of U.S. Provisional Patent Application No. 60/263,530 filed on Jan. 22, 2001, and U.S. Provisional Patent Application No. 60/301,761 filed Jun. 28, 2001. This application claims the benefit of U.S. Provisional Patent Application No. 60/453,053 filed Mar. 8, 2003, U.S. Provisional Application No. 60/453,664 filed Mar. 11, 2003, U.S. Provisional Application No. 60/458,156 filed Mar. 27, 2003, U.S. Provisional Application No. 60/465,314 filed Apr. 25, 2003, U.S. Provisional Application No. 60/472,310 filed May 21, 2003 and U.S. Provisional Application No. 60/483,783 filed Jun. 28, 2003 all of which are incorporated by reference as if set forth in full herein.

### BACKGROUND OF THE INVENTION

This invention relates generally to the field of shipping and more specifically to the delivery of goods purchased from a distant location.

Conventionally, products that are ordered by consumers, whether ordered on the Internet or by other means, are delivered primarily in two ways. In the first way, the buyer/consumer travels to the seller's store and picks up products ordered there. The second way, the seller ships the products to the buyer via common carriers and buyer receives products at the address designated. Both ways are inefficient. The first method costs the buyer the time and energy expended traveling to the seller's store to pickup products ordered. The second method on the other hand, costs the buyer shipping and handling charges and usually takes a considerable amount of delivery time for the products to be shipped.

U.S. Pat. No. 5,991,739, Cupps et al. disclose a system and method for providing an online ordering machine that manages the distribution of home delivered products over a distributed computer system. The patentee discloses that “(t)he online ordering machine provides the customers with product information from various vendors whose delivery range is within the customer's location or with product information from vendors having a take out service within a specified range from the customer's location.”

In U.S. Pat. No. 6,026,375 Hall et al. disclose methods and systems for processing an order form a mobile customer and with the use of a method of global tracking. A determination is made as to the completion of the order at a certain location at a certain time for the customer's arrival at that location.

Neither Cupps et al. nor Hall et al. disclose a method and system that allows the seller to conveniently place a pickup station, which is mobile in nature and is easy to relocate, to a place close to the user's daily commute route and thereby provides maximum convenience for the buyer/user to pickup products ordered.

A conventional delivery system can be inefficient. Besides the problems conventional delivery systems face as previously discussed, the delivery of products to a buyer's address, normally made during daytime, can be troublesome. The buyer may not be present at the buyer's address to receive the products and the products may either be left unattended at the buyer's address or the buyer has to pick the products up later at a common carrier's office. Even when a delivery is made to an office location where presumably someone will be at the address to receive the products, problems may exist. This is because the common carrier comes and goes following its delivery route and those buyers at the end of the delivery route may waste a significant amount of time waiting for the products to arrive. This waste of time may be crucial and can't be remedied unless a buyer pays a higher price for a faster delivery.

As we move into the Internet era, more and more people shop on the Internet. But lots of people are turned away from Internet purchasing because the long delivery time and expensive delivery charges involved. A number of business models have been developed to encompass the convenience of Internet ordering into the order of food, aiming at providing an easy solution of user's daily eating. Meal ordering related Internet business models, such as Food.com and Waiter.com that deliver food orders for participating restaurants, such as Chili's, Fresh Choice, or Subways, to users is either flawed or unprofitable. The major flaw in these business models are that the distance between the business entity (e.g. Food.com) to a participating restaurant (e.g. Chili's), and the distance between the participating restaurants to end user is too far away. Therefore, significant delivery costs occur when the entity picks up the user order at the participating restaurant and delivers it to the end user. To offset the high cost of delivery, a significant deliver charge is imposed on the user. Also, because of the high operating costs involved, a minimum order is required, which further impairs the user's interest to order.

An improved delivery system providing a more efficient way of delivery is, therefore, needed. The present invention meets such need.

### SUMMARY OF THE INVENTION

In one aspect of the invention, a method is provided for scheduling and delivery of an ordered product to a buyer along the buyer's commuting route. The method includes receiving route information from a buyer such as a set of roads the buyer travels on the way to and from work. The route information is used to generate a route for which a pickup point is selected and dispatching a portable locker station enclosing the ordered product to the pickup point.

In another aspect of the invention, the route selection method includes selecting a set of landmarks along the buyer's commuting route. From the landmarks, a shortest distance route is generated for selection of the pickup point.

In another aspect of the invention, the server sets up a default route for user, the default route may be set up using a shortest distance method or a least travel time method.

In another aspect of the invention, the route selection method includes selecting a set of landmarks along the buyer's commuting route. From the landmarks, a route with the least travel time to complete is generated for selection of the pickup point.

In another aspect of the invention, the route information supplied by the buyer includes at least two sub-routes. From the sub-routes, a complete route is generated by connecting the sub-routes with a set of shortest length routes.

In another aspect of the invention, the user is allowed to build a channel around the user's traveling route with various methods, such as straight-line distance method, a road-driving distance method, and a preferred traveling time method.

In another aspect of the invention, a Mobile Pickup Station (MPS) carrying a user order is dispatched to a pick up location waiting for the recipient to pick up the order the user ordered. The MPS may be further equipped with food catering/preparing equipment thereby creating a mobile kitchen.

In another aspect of the invention, the portable locker station includes a plurality of lockers for enclosing products, with each of the plurality of lockers having a unique access code. An access code is transmitted to the buyer for a locker enclosing the buyer's product which the buyer uses to unlock the locker and receive the purchases.

In another aspect of the invention, a data processing system is adapted to schedule and deliver an ordered product to a buyer along the buyer's commuting route. The data processing apparatus includes a processor operable coupled to a having stored program instructions. The program instructions are executable by the processor to receive route information from a buyer and generate a route from the route information. The process then uses the program instructions to select from a plurality of pickup points a pickup point based on the route and dispatch a portable locker station enclosing the ordered product to the pickup point.

In another aspect of the invention, a portable locker station includes a plurality of lockers, each of the plurality of lockers having an electronically actuated lock or bolt. A controller is electrically coupled to each of the electronically actuated locks and has means for storing a plurality of access codes associated with the lockers. A keypad, electrically coupled to the controller, is used by a buyer to enter an access code to unlock an associated locker.

In another aspect of the invention, the portable locker station further includes removable divides between adjoining lockers whereby a single locker is created from two or more lockers by removing the divider.

In another aspect of the invention, the portable locker stations further include a plurality of keypads with each keypad corresponding to a single locker from the plurality of lockers.

### BRIEF DESCRIPTION OF THE DRAWINGS

These and other features, aspects, and advantages of the present invention will become better understood with regard to the following detailed description, appended claims, and accompanying drawings where:

FIG. 1 and FIG. 2 are flowcharts showing the process from user's commuting route selection to user pickup at a mobile pickup station;

FIG. 3 is a flowchart showing an exemplary process to select available pickup points;

FIG. 4 is a flowchart showing third party buying coupling with a mobile pickup station delivery service;

FIG. 5 shows selection of mobile pickup point with two users;

FIG. 6 shows selection of mobile pickup point with new user joining in;

FIG. 7 shows the searching method by using user commuting route and user selected channel;

FIG. 8 shows user's input of occurrence frequency;

FIG. 9 shows a mobile pickup station with panel in an up position.

FIG. 10 shows the overlapping of user channels and server's selection of available pickup points.

FIG. 11 shows a first model of the arrangement of shipping third party products to a mobile pickup station warehouse.

FIG. 12 shows a second model of the arrangement of shipping third party products to a mobile pickup station warehouse;

FIG. 13 shows a third model of the arrangement of shipping third party products to a mobile pickup station warehouse;

FIG. 14 shows a fourth model of the arrangement of shipping third party products to mobile pickup station warehouse;

FIG. 15 is a flowchart presentation of the searching method by using user commuting route and user selected channel;

FIG. 16 is a network diagram depicting an embodiment of a MPS using the Internet as a communications medium;

FIG. 17 is a diagram of a computer architecture of a general purpose computer capable of hosting a mobile pickup station server;

FIGS. 18, 19, 20 are flowcharts of locker station operations in accordance with exemplary embodiments of the present invention;

FIG. 21a and FIG. 21b are an elevation and side view showing the construction of a locker station in accordance with an exemplary embodiment of the present invention;

FIG. 22 shows a MPS shipping sticker with order ID and bar code in accordance with an exemplary embodiment of the present invention;

FIG. 23 is a diagram presentation of multiple territories with covered routes in accordance with an exemplary embodiment of the present invention;

FIG. 24 shows a pair of lockers in a locker station in accordance with an exemplary embodiment of the present invention;

FIG. 25 shows the lockers in FIG. 24 with locker doors opened in accordance with an exemplary embodiment of the present invention;

FIG. 26 shows the lockers in FIG. 25 with divider in its up position in accordance with an exemplary embodiment of the present invention;

FIG. 27 shows the construction of divider and its relation to locker station wall in accordance with an exemplary embodiment of the present invention;

FIG. 28 shows two locker doors with the bolt at its down position in accordance with an exemplary embodiment of the present invention

FIG. 29 is a diagram presentation of a delivery system with subsidiary delivery personnel and transportation means in accordance with an exemplary embodiment of the present invention;

FIG. 30 is a diagram presentation of building of channel with two distance-defined channel width methods and one time-defined channel width method; and

FIG. 31 is a diagram presentation of building of channel using an optional time-defined channel width method.

### DETAILED DESCRIPTION

The present invention is referred to herein as a Mobile Pickup Station (MPS) delivery system. A MPS delivery system uses pickup stations in the form of vehicles or movable kiosks used in conjunction with the Internet to provide maximum convenience for a buyer to pickup products. A mobile pickup station may be stationed along a buyer's frequent commuting route so that a buyer can conveniently pickup products at these stations when traveling via the buyer's usual commute route without spending extra time traveling to a seller's store to pickup products.

Most people commute to work via the same commuting route everyday. Others, while not working, go to the same place repeatedly. Even the time people start and end their commuting and the time spent on commuting are about the same day after day. The mobile pickup station system encompasses this highly routine human behavior by arranging to ship products a buyer ordered to a location that is close to the buyer's daily commuting route. Under such an arrangement, a buyer can pickup the products while conducting the buyer's daily commuting without spending extra time to travel to a seller's store for picking up and therefore making it convenient for the buyer to receive products. This pickup location will be referred to herein as the mobile pickup point (or mobile pick up location).

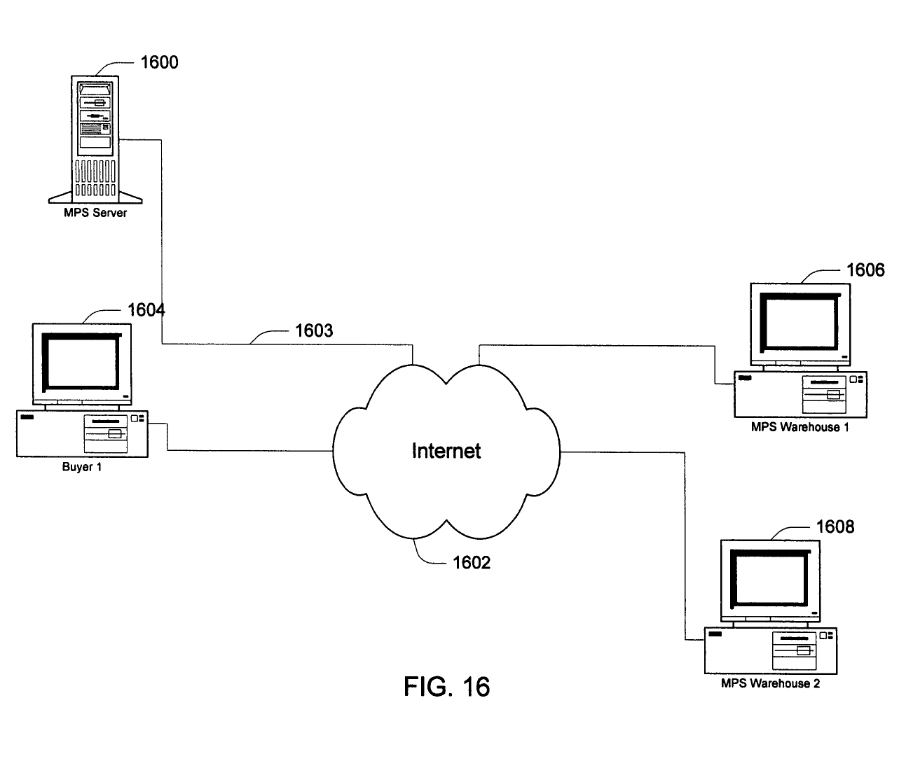

FIG. 16 is a network diagram showing an embodiment of an MPS server using the Internet. A MPS server 1660 is operatively coupled to the Internet 1604 via a communications link 1603 adapted for communications using the Transmission Control Protocol/Internet Protocol (TCP/IP) suite of networking protocols such as Hyper Text Transfer Protocol (HTTP) for hypertext document transfer and Simple Mail Transfer Protocol (SMTP) for the transfer of electronic (email) messages.

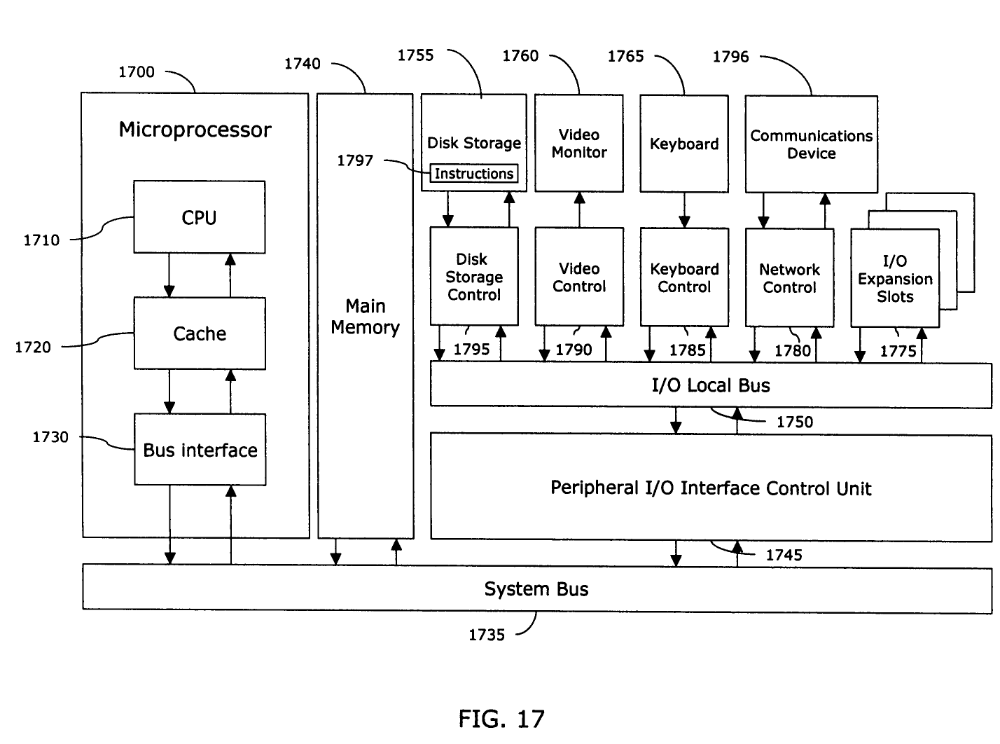

FIG. 17 is a hardware architecture diagram of a general purpose computer suitable for use as a MPS server host. Microprocessor 1700, comprised of a Central Processing Unit (CPU) 1710, memory cache 1720, and bus interface 1730, is operatively coupled via system bus 1735 to main memory 1740 and I/O control unit 1745. The I/O interface control unit is operatively coupled via I/O local bus 1750 to disk storage controller 1795, video controller 1790, keyboard controller 1785, and communications device 1780. The communications device is adapted to allow software objects hosted by the general purpose computer to communicate via a network with other software objects. The disk storage controller is operatively coupled to disk storage device 1725. The video controller is operatively coupled to video monitor 1760. The keyboard controller is operatively coupled to keyboard 1765. The network controller is operatively coupled to communications device 1796. The communications device provides a communications link adapted for communications over the Internet.

Computer program instructions 1797 implementing a MPS server are stored on the disk storage device until the microprocessor retrieves the computer program instructions and stores them in the main memory. The microprocessor then executes the computer program instructions stored in the main memory to implement a MPS server.

Referring again to FIG. 16, a buyer uses a computer 1604 running an Internet browser to access the MPS server via the Internet. The buyer's computer is operatively coupled to the Internet via a communications link adapted for communications using TCP/IP based networking protocols such as HTTP for hypertext document transfer. The MPS server provides scheduling services for at least one regionally distributed MPS warehouse. Each MPS warehouse communicates with the MPS via the Internet using computers as exemplified by MPS warehouse computers 1606 and 1608. Each MPS warehouse computer is operatively coupled to the Internet via a communications link adapted for communications using TCP/IP based networking protocols such as HTTP for hypertext document transfer and SMTP for the transfer of email messages.

In operation, a buyer accesses the MPS server via the Internet and uses the delivery scheduling services of the MPS server to define a pickup point to be used by the buyer. The MPS server determines which MPS warehouse is to be used to dispatch a MPS to the defined pickup point with the buyer's products.

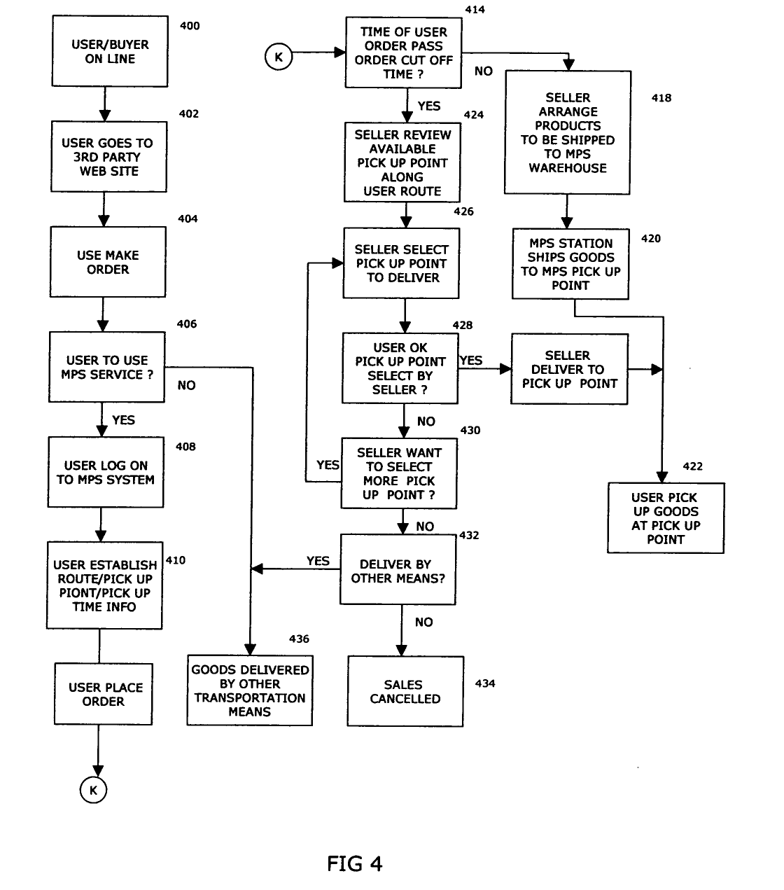

Referring now to FIG. 5, user A and user B use the Internet for shopping and order products at the server's website. User A and user B identify their daily preferred commute route as route segment AA 10 and route segment BB 12 respectively. An MPS system stores this route segment information in its permanent memory. Route segment FG 14 is a route segment common to both route segment AA and route segment BB. A MPS system may achieve maximum convenience for both user A and user B by sending a MPS station which carries products ordered by user A and user B and stations at a place that is common to route segments AA and BB (e.g. point J 18) to wait for user A and user B to pickup their ordered products.

A MPS is a vehicle or a movable kiosk that has the capacity to carry products. For instance, in addition to the ability to carry general nonperishable products, an MPS may be equipped with an electricity generator that may power a refrigerator to carry food or floral products during summer or a MPS may be equipped with a heating device to keep food products at an elevated temperature during winter etc. In one MPS in accordance with an embodiment of the present invention, the MPS is connected to a power source, such as a solar power panel or a conventional electrical connection, to receive power to cool or heat products carries. In another MPS in accordance with an embodiment of the present invention, one or more operators or attendants stay with the MPS station to operate it, for example to give products to buyer when the buyer/user comes to the station to pick up product ordered, to receive products from the user when he come to the station to drop off products or to prepare products to its ready condition and give it to user . . . etc.

In another embodiment of the present invention, a MPS may be equipped with computer, wireless transmitter and/or receiver so that it can communicate with a MPS server, get access to the Internet, get access to a MPS Intranet or communicate with users or other parties.

In another MPS in accordance with an embodiment of the present invention, the movable kiosk has a plurality of lockers and the buyer or user is given an ID code and/or a password to open the locker to take the products he ordered. In this case, it would not be necessary to have an operator or attendant at the side of the kiosk to server the buyer/user.

A pick up point can be anywhere as long as it can accommodate the parking of a mobile pick up station. An exemplary MPS mobile pickup point (e.g. point J) is a place that is close to the overlapped user route (e.g. route segment FG), is easy to get access to from the user route and is convenient for the user to park or to walk to. It may be the parking lot of a shopping mall, a gas station or a wide street with capacity to park a MPS.

A mobile pickup point may also be a place where the MPS system can station a movable kiosk, such as subway station or at a street crossing etc. A MPS stays at the pickup point for a determined period of time waiting for users to pickup their orders. If the MPS station is a vehicle, an operator drives the station to the designated pickup point and stays there. If the MPS station is a movable kiosk, a truck may drop the kiosk at the designated pickup point and pick it up and return the MPS to a MPS warehouse when the station time is over for reloading.

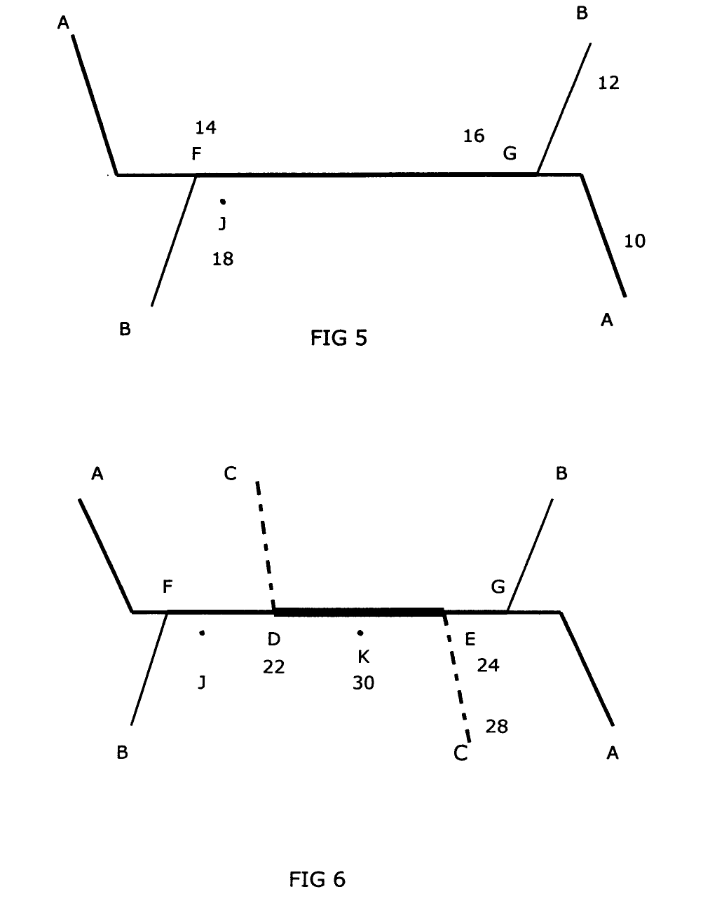

Referring to FIG. 6, assume user C joins a MPS system serving user A and user B. Further assume user C takes commuting route segment CC 28. Because pickup point J 18 is not within user C's commute route CC, the MPS system, in order to achieve maximum convenience to all users A, B, and C, must select a different pickup point to accommodate A, B, and C simultaneously. Point K 30, which is along route segment DE 22 and is common to all route segments AA, BB and CC, can thus be selected as a pickup point to serve users A, B, and C.

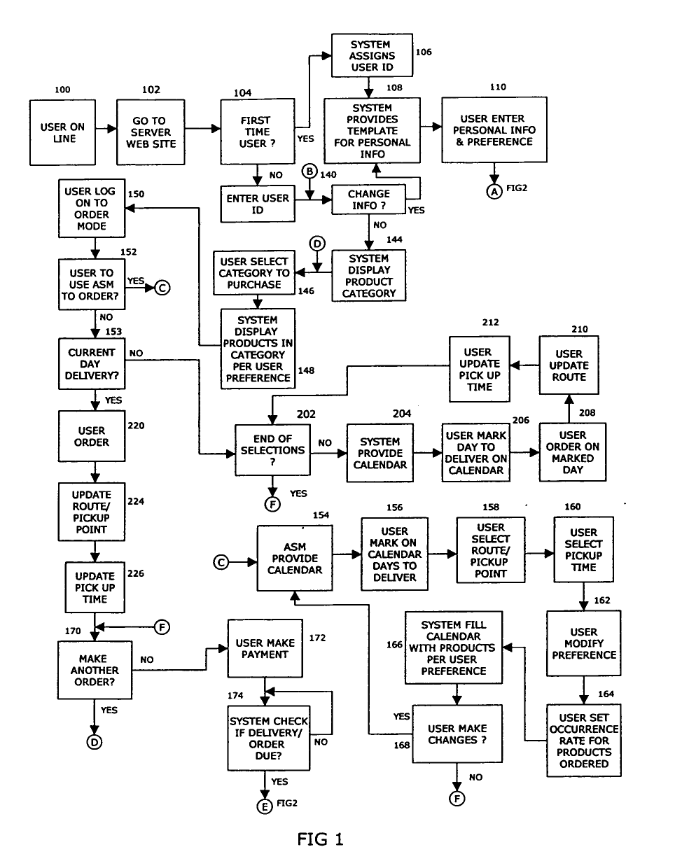

Referring to FIG. 1, a user/buyer uses at step 100 the Internet to access a Website using a Personal Computer (PC), a laptop, a palm pilot, a web accessing cellular phone, or any other means capable of accessing the Internet. The user/buyer is the person who purchases a product and/or MPS service from the Website. In the case where the Website is maintained by a transportation business entity providing MPS delivery services without selling any physical products, the buyer is the one who uses MPS services to have their products delivered.

The buyer goes to the Website hosted by a MPS server at step 102. An MPS server is a server maintained by a business entity that operates a MPS system. It may be a retail or wholesale business entity with a fleet of MPS stations. It may be a transportation business entity, which operates a fleet of MPSs and delivers products for its customers. Or it may be other kind of business entities, which operates a fleet of MPSs.

The server asks if the buyer is a first time buyer at step 104. If the buyer is a first time buyer, the system assigns the buyer an ID and a password for his/her use at step 106. The server provides a template for the buyer to enter his/her personal information at step 108.

The buyer may enter personal information such as name, address, phone number, age, credit card number, etc at step 110. At this stage, the server asks the buyer to enter preference of purchases. As herein used, purchases means purchases of products that include physical products and/or services. This preference is a tool the server uses later to screen products and display preferred products to the buyer. For example, if the server is maintained by a food manufacturing company, e.g. a food catering business, preference questions listed may be: does the buyer likes hot and spicy food? Should the food be slightly hot, medium hot, or very hot? Does the buyer cares for red meat in the food? Maximum calorie count, fat count in the food, the buyer likes Italian food, Japanese food or others etc. Also the preference questions may contain dollar limitations the buyer wants to spend on meals (or orders).

Referring to FIG. 2, the buyer then goes to a route selecting mode at step 112 to choose a commuting route. In this mode, a template is presented to the buyer to enter the beginning and the end addresses of the buyer's commuting route at step 114. In another embodiment of a MPS in accordance with the present invention, in defining beginning and end route information, the buyer/user is allowed to enter the zip codes or the telephone numbers of the beginning and end of the route. The system can then identify the general area of the beginning and end of the route and display a map that covers the general area of the beginning and end of the route with all possible routes available to the user. Well-known landmarks, city names or the cross streets with city information at each end of the user route can be used to identify the general area of the route in a similar fashion. When the system allows the user to enter the telephone number at each end of user route, the system uses the area codes and the prefixes of the telephone numbers to identify the general area of the beginning and end of buyer/user's commute route and displays the map. When the map that covers the general area is displayed, the server may display all available pick up points covered by the map for the user's selections.

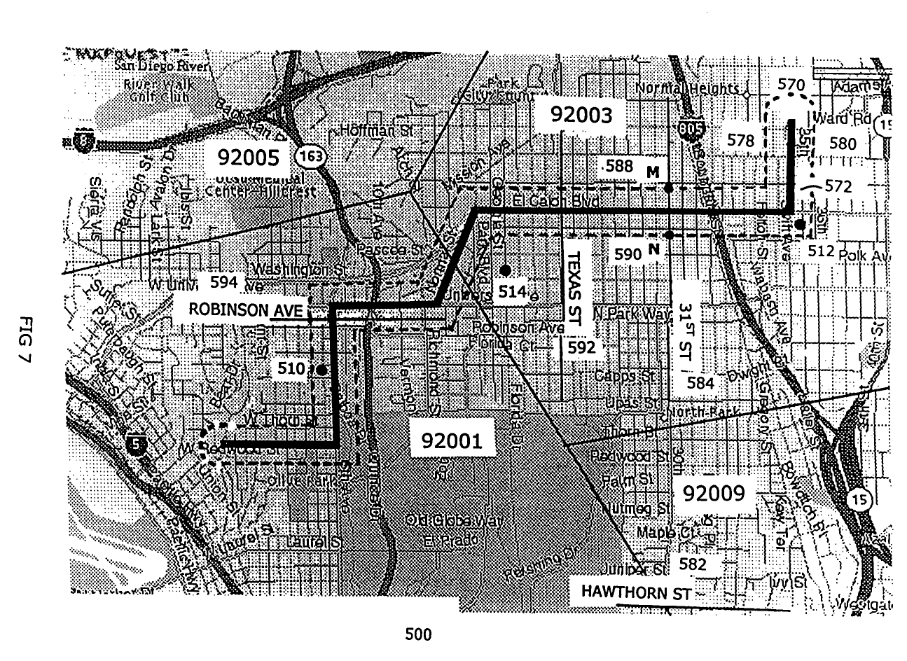

Referring to FIG. 7, in one embodiment of a MPS server, a MPS server displays a map 500 that covers the beginning and end address of the buyer's commute route. The map may display all streets and freeways between those two ends. The buyer clicks or depresses and drags the mouse across the map to define a chosen route 570. In another embodiment of the present invention, a buyer is prompted to enter a distance from the buyer's chosen route that the buyer is willing to travel to pickup a product. The distance a from the buyer's chosen route that the buyer is willing to travel is herein termed a channel width. The channel width is used by the MPS server to define channel boundaries 578 and 580 around the chosen route. This channel width combined with the buyer's chosen route creates a channel 572. As described herein, the server may present available pick up points along the user route for the user's selection. When available pick up points are presented along the user route, the server may display the channel to the user for the following purposes: the user/buyer may know the distance or location each available pick up point relative to the user route; (i.e. the buyer may use this channel as a distance reference); or the buyer may indicate to a MPS server that this channel width is the distance the buyer is willing to travel away from the buyer's commute route. In the latter case, the server may only display those available pick up points that fall within user channel.

There are two methods to determine the distance-defined channel width, the straight-line distance method and the road-traveling distance method. “Straight-line distance” is defined as the straight line distance between any two points. To define straight-line distance channel boundaries, the server may select a point on a user chosen route. The point selected may be any point on the user chosen route. The server then uses the point selected as center and uses the selected channel width as a radius to draw a circle. The points on the circle that are the farthest away from the user route are straight-line channel boundaries. A channel is then a collection of channel boundaries.

Because of difference on road conditions, the road-traveling distance (the driving distance on the road through a path connecting any two points) and the straight-line distance between any two points may not be the same. For example, when a user gets out of his/her commute route to pick up an order, the road that leads the user to the pick up point may be curved. The road-traveling distance (or road-driving distance) from the point the user exits his/her commute route to the pick up point may be far greater than the straight-line distance between these two points.

A preferred road-traveling distance is the distance a user is willing to travel on the road away from the user selected commute route. For example, a preferred road-traveling distance of two miles means the user is willing to drive two miles on the road away from his selected commute route to pick up an order.

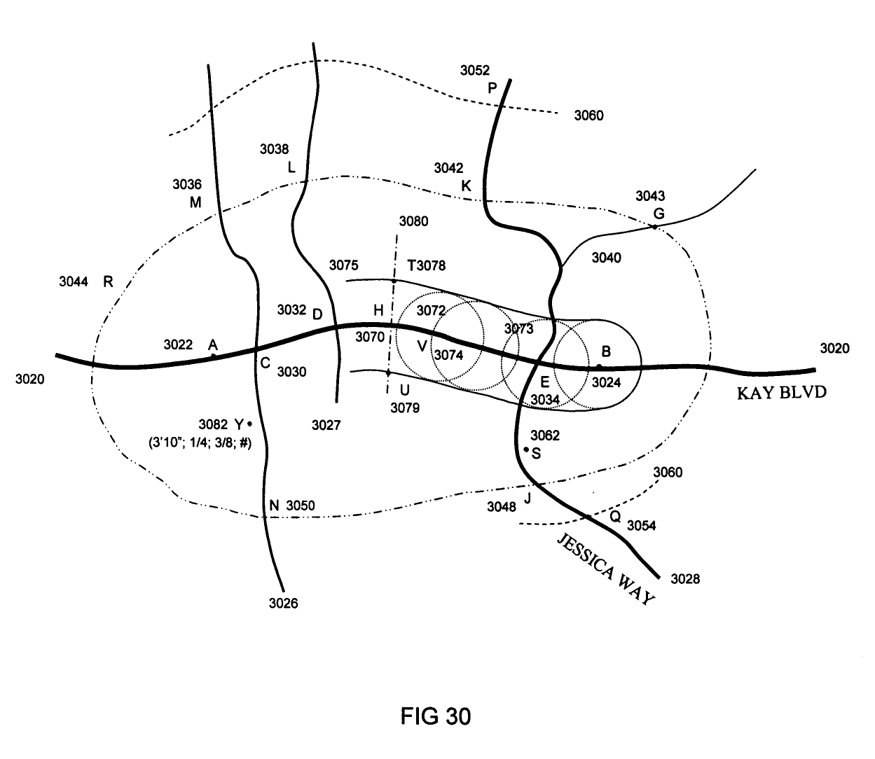

When using road-traveling distance to build a channel, the server may first find all exits and paths a user may use to travel away from the user route. The server then uses the preferred traveling distance selected by the user (or set by server default) along all the drive away paths to determine the channel boundary. Referring now to FIG. 30 as illustration, assuming user Allison's selected traveling route is Kay Blvd 3020 between point A 3022 and point B 3024. Also assuming that between A and B, there are several exits, e.g. C 3030, D 3032 and E 3034, user Allison may use to travel away from her selected route 3020. Assuming Jessica Way 3028 (with exit E 3034) is one of the paths (e.g. 3026, 3027, and 3028) user Allison may use to drive away from her travel route, Kay Blvd. If user Allison selects a road-traveling distance channel width of ½ miles, the server then set the channel boundaries along Jessica Way 3028 at K 3042 and J 3048 which are both ½ miles driving distance away from exit E 3034. The collection of J, K and other similar points, such as L 3038, M 3036 and N 3050, forms a road-traveling distance channel R 3044. The channel R 3044 is then defined by the road-driving channel width of ½ mile. Note that Jessica Way may curve and the straight-line distance from the exit E 3034 to the boundary K 3042 may be a lot shorter than ½ mile. In case Jessica way may branch out by crossing with other streets, such as street 3040, the branch-out street 3040 and the original path forms an extra path. The ½ mile road-traveling channel boundary along this extra path is set at G 3043, a point with ½ mile road traveling distance away from the original exit E.

When building Straight-line distance channel, the server may select any points, such as V 3074, B 3024 that is within the user selected traveling route AB as centers and use the selected channel width as radius to draw circles, such as 3072, 3073. The server then draws an envelope 3075 that surrounds and attaches to the farthest points out from user route of all circles. This envelope is the channel that is defined by the selected straight line channel width. In FIG. 30, 3075 shows a portion of the channel. As an alternative to determine the straight-line channel boundaries, the server may select any points such as H 3070 on user selected route and draw a line 3080 vertical to the user route at point H. The server then selects points along 3080 that are at the selected channel width away from H 3070. The points selected T 3078 and U 3079 are straight line channel boundaries. The collection of channel boundaries defines the channel.

The system may allow the user to select either a straight-line distance method or a road-traveling distance method or both to build a channel.

In another embodiment to define a route, the server may allow the buyer to click on the map (or to enter the names of) some or all the streets or highways the buyer prefers to travel, the MPS server will connect those streets or highways together with the shortest distance and further connect the buyer's beginning and end addresses to build a chosen route.

The buyer may use the following procedures to click and build his/her chosen route on a map 500. The buyer starts with his/her beginning address, e.g. his/her home address, at this time the MPS server registers a reference point, which is the buyer's home address on the buyer's home street. The buyer then clicks on the map a second street the buyer will travel. The intersection of the second street and the buyer's home street become a second reference point.

The system registers the route between the first and the second reference points as a portion of buyer's chosen route. The buyer then clicks a third street the buyer will travel. The intersection of the second and the third street becomes a third reference point. The MPS server then registers the route between the second and the third reference points as a portion of the buyer's chosen route. The buyer keeps going on with the process until the buyer reaches the buyer's end address, which would be the buyer's final reference point. The MPS server registers a final route portion and the whole route may thus be identified as the buyer's chosen route.

Alternatively, the buyer starts a route selecting process by clicking on the map one of the streets within the buyer's commuting route, the buyer then clicks on the map the streets the buyer travels before and after that street. The system then uses the intersections of these streets to establish reference points for the MPS server to construct the buyer's route. In the case where the buyer forgets or neglects to click to identify any of the traveled street(s) within his/her route, the system searches street(s) that represents the shortest traveling distance between the clicked streets and connects those clicked streets. The same method can be used to connect the clicked streets to the buyer's beginning and/or end points of route. For example, if the buyer clicks the second and the fourth traveling streets, thus creating a set of sub-routes, and forgets to click the third traveling street in the route, the system then generates a route by connecting the second and the fourth street with street(s) with a sub-route that represents the shortest distance between the two sub-routes to complete a whole route.

In another embodiment of the present invention, after the user enters telephone numbers, zip codes, city names or landmarks to identify the beginning and end of a route, the system displays a map that covers the general area of the route. The system may also displays all available pick up points covered by the general area for the user's selection. Here, the user may select the user's preferred pick up point without building the user's preferred traveling route. However, if the user wants to establish a route within the general area, the user can then enter his/her beginning and end traveling address or can use his/her mouse to point the cursor at the places he wishes to travel, and click on them. The system will then register those addresses or clicked points as reference points to establish the route. This method can be used to establish the beginning and end of a user route.

Because zip code, telephone number, city name or other similar identifier represents an area instead of a point, the server system may use the center of the area, a well-known landmark in the area or other location in the area to establish reference point, in case a reference point in the area is needed (for example: to establish a route . . . etc).

In another embodiment of a route selection system in accordance with the present invention, the system may present to the buyer a default route with the shortest travel distance to connect the beginning and end of the user route when the beginning and the end of the route are determined. Major highways and/or major streets may be incorporated into the default route.

In another embodiment of the present invention, there is another option of building a default route. In this embodiment, the MPS server may display to the user a route that takes the least expected time to travel through. A Least Expected Travel Time Route (LTTR) is built as follows. A street or road of a city or a region consists of a number of blocks (or sections). A section is defined as a portion of the street or road that consists of several blocks. The MPS server may measure the expected time (or average time, termed expected time hereafter) a driver spends in traveling through each block or section in the region. By using this information the server may be able to obtain the expected traveling speed (or average traveling speed) an average person travels through a section or block. The MPS server may collect this information by hiring drivers who drive through each block and/or section in the region on different days and at different times in a day. The drivers record the time spent and the speed traveled when driving through each block or section. For example, the server may hire drivers to drive through each block or section in a city from Monday through Sunday and from 5:00 a.m. to 8:00 p.m. each day. The drivers then record the speeds traveled and times taken to travel through each block (and/or section) in the city by day and by the time of day. Because stop signs, signal lights, and possible construction work involved on the streets, the drivers may record the time it takes to wait at each stop signs, signal lights, and construction sites. The drivers may also record the time it takes to finish a section of the street. These records are stored in the MPS server system. Collection and analysis of these data will enable the server to identify the expected time a traveler spends traveling through a block or a section, each day and at different times of the day.

When a user logs on to the route selecting mode and enters the beginning and end route identifiers, the time and day of the traveling, the system finds a route that takes the least expected time to complete, the LTTR, and presents it to the user. The system finds the LTTR by building all the routes that connect to the beginning and the end route identifiers input by the user. The system then computes, for all the routes, the expected time to complete a route. The expected traveling time to complete a route is the total of expected time spent on all blocks (or sections), on all stop signs, signal lights and construction sites . . . in a route for the time and day the user specified. The route with the least expected time to complete is the LTTR and is presented to the user.

Instead of having the driver record the time and speed when traveling through each block, section, stop sign, signal light . . . etc., an MPS server may utilize a radio signal transmitter installed on the driver's car. By tracking the signals transmitted from the driver's car, the MPS server may record the time the driver spends on waiting at each stop sign, traffic light . . . etc. The server may also measure the speed and time the driver travels through each block, section . . . etc.

In another embodiment of the invention, another option to measure the time and speed when traveling through each block (or section) of a street is provided. In this embodiment, a MPS server may use satellite images to determine the time and speed a car travels through a block or a section of a street. For example, a satellite image collected by the server on Jan. 3, 2003, 08:31:30 may show a car at one spot on a street, few minutes later, another image shows the same car at a different spot on the same or another street. Collection and analysis of these images will enable the server to determine the expected time a traveler spends traveling through a particular block or section, the expected time a traveler spends on waiting at a particular signal light or stop sign . . . etc, each day and at different times of the day.

In another embodiment of the present invention, where the driver-collected expected travel time/speed or the satellite-imaged expected travel time/speed are not available, or a rough estimate that is less costly would satisfy users, estimations may be used by the server. Any estimate, as long as is reasonable may be used to estimate the expected traveling speed. Such estimates may include but not limited to the speed limit imposed by traffic department for each block (or section) of a street. Together with the length of the block (or section), the server may estimate the expected travel-through time for a block (or section). The server may further modify the estimation of expected traveling speed by incorporating the following factors. For some of the areas, the street speed limits imposed by traffic department may not be the same for different times of a day. For example, for a street that is adjacent to a school, the speed limit may be lower at about 3:30 p.m., the time the school class is off. Also, the street speed limits usually do not reflect the expected traveling speeds of a street at different times of a day. For instance, the expected traveling speed on Main Street at 5:00 a.m. may be 40 miles per hour, the imposed speed limit, but the expected traveling speed at 5:00 p.m. may only be 20 miles per hour. The server may sample some of the streets at different times of a day the relationship between the effective traveling speed and the imposed speed limit at those times and used these data to estimate the expected traveling speed for other streets in the region for different time of a day. For example, the speed limit in Main Street is 40 miles per hour in city A, the server's sample of the expected traveling speed at 11:00 a.m. on a Monday shows 30 miles per hour, and 20 miles per hour at 5:00 p.m. The expected traveling speed/speed limit ratio is 75% at 11:00 a.m. and is 50% at 5:00 p.m. The server may use these ratios to estimate the expected traveling speed of other streets at different times of a day in city A. For example, the speed limit of Broadway is 50 miles per hour; the server may then use the ratio collected from Main Street to estimate the expected traveling speed of Broadway at 11:00 a.m. on Mondays to be 37.5 miles per hour and at 5:00 p.m. on Mondays to be 25 miles per hour. The user may also use similar statistics from nation, state, county, city or local agency to obtain these ratios.

The server may also use the statistics collected from nation, state, county, city or local agencies to estimate the average time a driver waits on a stop sign and/or a traffic light. By using the above data, the server may determine the total expected travel time to travel through a block or a section of a street in a region by a user.

The user may then enter to the system the time (e.g. 8:00 a.m.), day (e.g. Monday) and traveling route identifier(s) of his/her traveling. The system may, according to the information provided, calculate the LTTR and present it to the user.

Major highways and/or major streets may be included into user route by default and the LTTR will be calculated with these highway and/or streets be included in user route.

Once the expected travel-through time is determined for a section or a block in a region, the server will be able to determine the expected traveling speed a user travels through a section or a block in a street in a region.

In another embodiment of the present invention, the server may allow the user to select a channel width that is defined by the length of time a user is willing to spend traveling out of his/her commuting route to pick up an order. It is a time-defined channel width and is different from the channel width option that is defined by the straight-line distance or road-traveling distance as described before. In this embodiment, the user is allowed to select a preferred traveling time he/she is willing to travel out of his/her commuting route to pick up his/her order. The server may then display a channel to the user that is defined by the user selected preferred traveling time. The process of determining such a time-defined channel may be disclosed as follows:

As previously described, the server may be able to determine or estimate the expected traveling time and the expected traveling speed a user travels through each block or section of a street in an area. By using this technique, the server may allow the user to select a preferred traveling time and use this preferred traveling time to build a time-defined channel. In one of the embodiment of the time-defined channel, the channel width, which is the driving distance from an exit of user commute route to channel boundary, is determined by how far, on average, a user may travel away on the road from an exit of the user traveling route limited by the user selected preferred traveling time.

Referring now to FIG. 30, the server system identifies all the paths (e.g. 3026, 3027 and 3028) a user may use to exit and travel away from the user selected commute route 3020. Within each path, there may be a combination of sections, blocks, stop signs and traffic lights. The server may hire drivers to drive along each path that may travel away from user commute route. Subject to the traveling speed limits in each block or section in the path, the drivers travel along all paths and mark each unit time elapses and record the location the driver reaches at each unit time. The collection of all average points the driver reaches in all paths at a defined traveling time forms a channel. To illustrate, refer to FIG. 30, assuming the defined traveling time is five minutes, the hired driver drives away from a user route 3020 through a travel-away path 3028 from exit E 3034 for five minutes and, on average, may reach point P 3052 or Q 3054. P and Q are then set as channel boundaries defined by five minutes. The collection of all points P and Q for all the drive-away paths forms a channel 3060, partially displayed here, with a defined time of five minutes. The channel width of a defined traveling time (e.g. 5 minutes) is then the average driving distance from an exit point (e.g. E 3034) of a user route (e.g. 3020) by an average driver to drive along a path (e.g. 3028) for the defined traveling time, five minutes in our example. Note that even with the same defined traveling time, the road-traveling distance between any two points may not be the same. For example, with the same selected traveling time the road driving distance between E 3034 and P 3052 may be much larger then that of E 3034 and Q 3054. This is because a school S 3062 is located along EQ and the maximum allowable driving speed around the school is much lower.

The server may collect all channels represented by different traveling time for the user to select. The user selects a preferred traveling time and the server display a channel to the user according to the selected preferred traveling time.

The server may build these channels by physical traveling as described or by computer simulation. A computer simulation can easily be done since all factors needed, such as: all the driving-away paths pertained to a user selected traveling route, the numbers of blocks or sections in each path, the distance in each block or section within the path, the number of stop signs and/or traffic lights in the path . . . etc, are all known. Other information needed, such as: the expected traveling speed in each block, the waiting time at each stop sign and traffic light, the maximum allowable driving speed in a block or section . . . etc, are all known through information collected as described before. The server may use this information to simulate channel width for each traveling-away path according to the user defined preferred traveling time. The collection of these channel widths forms a channel.

In the case where actual collection (by physical driving or satellite imaging as described before) of information such as expected traveling speed in a block and/or the waiting time for a stop sign (or traffic light) . . . etc, are not available, or in the case rough estimation that are less costly may satisfy users, the server may use any reasonable means to estimate the expected traveling speed or waiting time. Such estimation means may include but not limited to: the use of the maximum traveling speed in a region to estimate the expected traveling speed or the use of national, state, county, city or local statistics to estimate how long a average driver may wait for a stop sign (or for a traffic light). Also, by knowing the distance in each block/section and the expected traveling speed, the server may estimate the time a driver may travel through the block/section. All other timing factors that affect the traveling speed on a street (e.g. the allowable traveling speed of a street during off class time is lower then that of regular time . . . etc) as discussed before, may be incorporated into traffic speed/time calculation. The server may incorporate these parameters into computer simulation to calculate channel widths for each user selected preferred traveling time in different day and different times of a day and produce channels for user's selection.

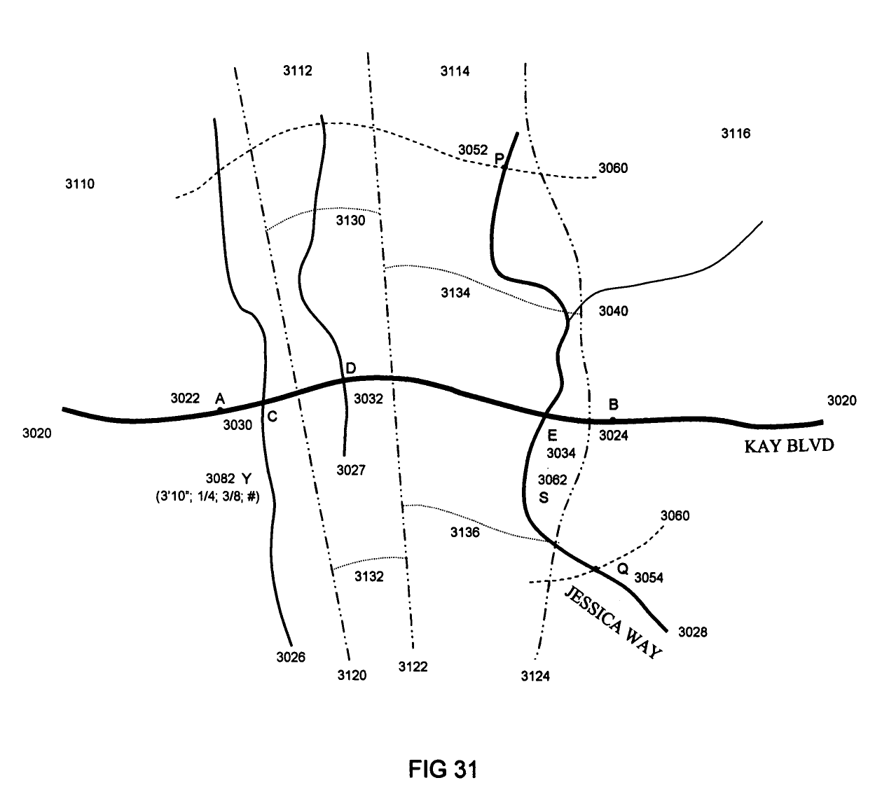

The above mentioned time-defined channel building method measures how far away on average a user can travel “on the road” within the defined traveling time. The method often involves determining the speed and traveling time on paths that may curve and the calculation may be difficult. In the case where a rough estimation of traveling time would be enough to satisfy users, the server may build the time-defined channel using a concept similar to the straight-line distance concept as described before. In this embodiment, the curving of paths is disregard. Referring now to FIG. 31, in this embodiment, the server divides the area defined by user selected identifier(s) into divisions, such as division 3110, 3112, 3114 and 3116, by division boundaries 3120, 3122 and 3124. The server may divide a user identifier-defined area into several divisions or may keep the area to only one division. The decision to divide an area into divisions may be made according to traffic conditions. For example, as shown in FIG. 31, the server may divide division 3112 and division 3114 as shown because division 3112 is a rural area the average traveling speed is faster and division 3114 is an urban area the average traveling speed is slower. The server may then determine the channel width in each division by the following procedure: The server calculates the average traveling speed in a division. The server may also compute the average distance between traffic lights, stop signs . . . etc in that division. The server also calculates the average waiting time a user spends waiting for a traffic light and/or a stop sign. As the waiting time at a stop sign is usually shorter then that at a traffic light, the server may choose to ignore stop signs in determining waiting time. Assuming the average traveling speed in division 3112 is 30 miles per hour (or ½ mile per minute). The average distance between two traffic lights in division 3112 is one mile and a user on average spend one minute in waiting for traffic lights. Also assuming the server disregards stop sign waiting time computation because it is usually small. Suppose the user selects a preferred traveling time of four minutes. In the first two minutes, the user travels one mile. The user then encounters a traffic light because the average distance between traffic lights is one mile. The user spends another one minute waiting at traffic light. The user then spends the remaining one minute to travel another ½ mile. The total traveling distance by the user is 1½ miles. The server then uses this distance to build channel boundaries 3130 and 3132. Each of these two boundaries is 1½ miles away from user route 3020. These channel boundaries, which are within division 3112, are defined by a user selected preferred traveling time of four minutes. Note that the curving of path is disregarded in this embodiment of boundary computation. Also, the average traveling speed is different in different divisions; the same preferred traveling time may yield different channel widths in different divisions. For example, division 3114, because it covers an urban area, its average traveling speed may only be 15 miles per hour. The channel width defined by four minutes in this division would be only one mile as indicated as 3134 and 3136 (FIG. 31).

In another embodiment, the server may include the waiting at stop signs and traffic lights into the calculation of the average traveling speed in a division. For example, when includes waiting time at traffic lights and at stop signs, the server calculates the average traveling speed in a division is 10 miles per hour. The preferred traveling time of six minutes selected by the user in this division will yield channel boundaries that are one mile away from user route.

The server, besides using the average traveling speed to compute channel width, may use any other means as long as is reasonable to estimate traveling speed to perform the computation. Such means may include but not limited to: the maximum traveling speed or the mean traveling speed in a division . . . etc.

Because the traffic condition of a street (or road) varies in different days and/or different times in a day, the server may allow the user to specify a day and the time in the day when the user wants to receive channel information. The term “traveling” in the present invention means traveling with transportation equipment such as vehicles, motorcycles, bicycles . . . etc. It may also mean traveling without transportation equipments such as by walking . . . etc. When the transportation equipment is a bicycle or other man-powered equipment, the average traveling speed by such equipment is used when determined expected traveling speed. If human walking or running is involved, the average walking or running speed is used in determining expected traveling speed.

The server may allow the user to use any of the straight-line distance method, the road-traveling distance method, the two preferred traveling time methods or any combination of these methods to build channel(s). The server may also allow the user to select his/her preferred straight line distance, preferred road traveling distance or preferred traveling time (straight line concept or road traveling concept) to build his/her channel. The server may set default straight line distance, default road traveling distance or default preferred traveling time (straight line concept or road traveling concept) to build user channel in case the user neglects to define his/her selected parameter. Any of the above channel building parameters, i.e. straight line distance, road traveling distance or preferred traveling time may be selected by the user (or set as default by the server) with any number(s) ranged from zero to infinity.

When the user-selected identifier is a zip code, telephone number or city name it may by itself define an area. If the user selected identifier is an address, which represents a point, a channel width may be selected either by user selection or by default to define an area. If the selected channel width is a straight-line distance, the defined area is a circle around the identifier (an address) with the identifier as center and the distance as radius. If the identifier is an address and the channel width is defined by road-traveling distance or by preferred traveling time, the shape of the defined area may be irregular. The area is then defined by connecting boundaries that are defined by the selected road-driving distance or the preferred traveling time.

In another embodiment of the present invention, the buyer is allowed to change any portion of the default route built by the methods disclosed in the present invention as he/she wishes. A template may be provided to the buyer to enter via keyboard the highways or streets buyer wants to travel out of the default route. Or, the user may click on the map the places, the highways or streets the user wants to travel out of the default route. The system then connects these selected places, highways or streets to the default route with routes with the shortest distance or the shortest traveling time. A drop down menu that contains defaulted streets and/or highways may be used to allow the buyer to click on and select his/her desired traveling route.

After the user selects his/her desired travel route, the system may display to the user the expected travel time to travel through the user selected route by using the method described before.

Referring again to FIG. 7, assuming the buyer chooses a straight-line channel width, e.g. ¼ mile, and indicates that the channel width is the distance he/she wants to travel away from the route. The MPS server displays two channel boundaries 578 and 580 that wrap around and extend along the chosen route 570 with the distance from a boundary to the chosen route equal to ¼ mile. The area between the channel boundaries defines a channel around the chosen route. The MPS server displays all available pickup points 510 and 512 covered by the channel.

If there are no pickup points within the channel, the MPS server may then display those pickup points around the channel such as point 514. The MPS server at this time may decide if the MPS server wants to relocate a pickup point to a place within the channel or the MPS server will wait till condition permits, e.g. more buyers use the same route, to establish an extra pickup point to serve the buyer. If the MPS server determines that no new pickup point should be established, the buyer selects a pickup point (e.g. 514) outside of the buyer's channel.

Referring again to the process flow diagram of FIG. 2, once the beginning and the end address of route are defined, the MPS server displays a map with all the possible routes involved at step 116. The buyer then clicks or depresses and drags the mouse key on the map described in FIG. 7 to define the buyer's chosen route at step 118. The buyer can choose to set the chosen route as a default route at steps at step 120 and at step 122. If the chosen route is a temporary route because the buyer is temporarily traveling along a new commute route, the buyer may not want to set the chosen route as a default route. The buyer selects a width for the MPS server to develop a channel around a chosen route at step 123. The MPS server then displays a channel that wraps around and extends along the route at step 124 with the defined width. The MPS server displays the channel as previously described in FIG. 7. The system displays all available pick up points 126. The buyer uses the buyer/user's mouse to click a pickup point at step 128 to select the user's preferred pick up point. The system then records the selected pick up point and its address. The server then registers the address of the selected pick up point as the delivery address of the user/buyer order. The delivery address is then included in the shipping label that is to be attached to the user order later. The buyer can set the pickup point to be the buyer's default pickup point if the buyer desires, see steps 130 and 132. The buyer also may enter the buyer's preferred pickup time at step 134. He may also set this pickup time as a default at steps 136 and 138. The server may set a station time as the time a MPS stays at the pickup point. For example, the MPS server may set station time between 4 p.m. to 7 p.m. or 6 a.m. to 9 a.m. and the buyer comes between those times to pickup the buyer's products. If no station time is set, a MPS may stay at the pickup point until all buyers pickup their products.

The pickup time entry, in the case of no station time being set, gives the MPS server a planning tool as how long a MPS will stay at a pickup point before the MPS is sent to a next assignment.

In one embodiment of a MPS server, the pickup time entry may be also used as a guide to send a reminder to the buyer for pickups. For example, if a buyer enters 7:30 a.m. as the buyer's pickup time, the MPS server may send a reminder at 7:00 a.m. to the buyer to remind the buyer that he has an order to pickup. The reminder may be very important if the order is to be picked up early in the morning. The reminder may be in the form of telephone calls to the buyer's office, home, or cellular phone. It may also be in the form of e mails or messages sent to a buyer's palm pilot or it may be by other means permitted by technology.

The preferred pick up time entry may be used by the MPS operator as a guide for the timing of the preparation of the user order as will be discussed later.

When entering the beginning and end route identifiers, if the user enters only one identifier and leave the other identifier un-entered, the system will treat the un-entered identifier the same as the one entered. The beginning and end route identifiers may be entered as the same. In this case, the defined user commute route is a point. The system may allow the user to enter one identifier only. If the identifier entered is an address, which defines a point, a channel width may be used to define an area to display pick up points. If the identifier entered is a city, telephone number, zip code, famous land mark . . . etc which by itself may define an area, available pick up points may be displayed within the defined area for user's selection. In short, the MPS server may display (or at the request of the user to display) a map with available pick up points for the user's selection. The map is defined by the user selected route, user selected channel, user selected location identifier(s), server default route, server default channel, or server default location identifier(s) and/or other identifier(s). As an alternative, the server may display (or at the request of user to display) a list that contains available pick up points defined by all above mentioned identifier(s).

It is to the server's advantage, if the server can limit the number of available pick up points users may select to as few as possible although there may be many more pick up points available for selection. In other words, it is to the server's advantage if the server may direct more users to select a common pick up point to pick up their orders. Because with such an arrangement, the number of orders delivered by each mobile pick up station will be higher thus more cost efficient. In order to direct users to select common pick up points, the server may display only a few, e.g. one or two, of the available pick up point(s) for users' section. The users are then forced to select the displayed pick up points. The server may present other pick up points for user to select when the orders that are to be delivered to the displayed pick up point reaches the maximum delivery capacity of the mobile pick up station assigned to it. Also, the server may display other pick up points for user to select if user expresses dissatisfaction of the pick up point(s) displayed and wants other selections. The server may thus select to present any (or any number) of pick up point(s) among these available pick up points for the users' selection as long as it may justify the cost.

The server may present to different users with different pick up points for selection even thought these users share common travel routes or use common route identifiers.

The server may assign more then one pick up stations to any pick up point. Also, if in an area (or in a route), there is only one pick up point that is available for user to select, the user has to select that pick up point or do not use the server's service.

The user may then select his/her preferred pick up point among these available pick up points displayed to him/her. In another embodiment of the present invention, the server calculates the closest “Y” pick up points around the user's selected identifier (e.g. user's home . . . etc) or to the user travel route. The closest distance may be defined by the straight-line distance method or the road-traveling distance method discussed before. The server then displays these pick up points to the user. Or, the server may calculate “Y” available pick up points the user may spend the least travel time to reach from the user's selected identifier or from the user travel route according to the preferred traveling time method discussed before and displays these pick up points to the user. “Y” is the number of available pick up points selected by user or by server default.

In another embodiment of the present invention, the server, when displaying available pick up points for the user's selection, may display information such as the expected traveling time, straight-line distance and/or road-traveling distance from an exit, along side the pick up point to aid the user's decision. Other information associated with each available pick up point, such as the name of the pick up point, signs to identify the pick up point, activities occurring at the pick up point, etc. may be displayed as well. For example, in FIG. 30, Y 3082 is an available pick up point. The symbol (3′10″; ¼; ⅜; #) along side Y 3082 may mean the expected traveling time from Y to exit C 3030 is 3 minutes and ten seconds, the straight distance from Y to exit C is 1/4 miles and the driving distance from Y to exit C is 3/8 miles. The # sign may mean special activities such as, merchandise sale, free coffee . . . etc occurs at the pick up location. The user may click at the # sign to receive detailed information. In the case where a list, instead of a map, is used to display available pick up points, these information then can be displayed on the list along side the available pick up points. With these information displayed, the displaying of the channel itself may be unnecessary.

When building channel, the server may allow the user to select a channel width or the server may set a default channel width for the user. The channel width can be defined by road-driving distance or straight-line distance or preferred traveling time. The width of user selected channel width or default channel width may be any number from zero to infinity. When the user forgets or ignores to select a channel width, the server may display to the user a channel with default channel width.

In another embodiment of the present invention, the MPS server may allow the user to enter more then one (i.e. two, three, four or more) identifiers to identify the general area or localities the user wants pick up locations to be displayed for the user's selection. The route may or nay not be built by user or by server default. When building a travel route with multiple identifiers, the travel route is built in a way that connects all identifiers entered. A channel width may be selected by the user or set by server default.

In the present invention, the general area, locality or localities as stated is defined by city (or cities), zip code (or zip codes), area code (or area codes) . . . etc that covers the selected identifier(s) and the region between these identifiers if multiple identifiers are involved. The general area, locality, or localities may simply defined by the map that is presented to the user on the user's computer screen and covers the identifier(s) and the region between these identifiers if multiple identifiers are involved.

Referring again to FIG. 1, after finishing input of all setup information, a buyer proceeds to step 140. The MPS server displays product categories for the buyer to choose if the buyer does not want to change any information at step 144. Product categories are different groups of products sold by a seller. For a food producing company (e.g. a food catering business or a lunch/dinner delivery business) the categories may be: drinks, wine, Italian food, French food, Japanese food, deserts, pizza or other products the server is selling. The MPS server may display only those categories that match the buyer's preference and disregard those that the buyer is not interested in purchasing. The buyer clicks on the category the buyer wants to purchase at step 146. The MPS server brings up all products under category buyer selected at step 148. After screened by category, the products displayed may be subject to the same screening process as previously described, which is, only products that match the buyer's preference are displayed and any other products are disregarded. The MPS server may display product features along with products. Those features displayed may be: ingredients, calorie counts, fat count, and price etc. The MPS server may also employ newly developed technology that gives out the scent of the food when buyer reviews its product information to stimulate purchases. The buyer may cancel previous orders or, after reviewing product items, decide to order and continues to order mode at step 150.

In one embodiment, a MPS server provides an Automatic Selection Method (ASM) service. This is a MPS server service designed for a buyer, who does not want to go through the trouble of ordering manually repeatedly and, after establish the buyer's preferences with the MPS server, wants the MPS server to fill orders for the buyer according to the buyer's preferences. As an example, a buyer may set up a buyer's preference as follows: calorie under 600, fat under 30 grams, no red meat, no onion etc, uses the MPS server to order food at step 152.

The MPS server follows the following steps to fill orders for him: The MPS server displays a calendar at step 154. The buyer marks on the calendar to indicate the days on the calendar the buyer wants to order products to be delivered at step 156. As an alternative, the system may allow the user to identify those days the user does not want service to be provided and the system books service for these days the user does not identify. The system may allow the user to enter other selection options, such as: service to be provided for every Monday and Wednesday only, every Monday, Tuesday and Friday only, service to be provided every weekday, service to be provided excluding or including holidays, or to be provided on any combination of days . . . etc. The calendar the server presents to the user may be in any form as long as a user may use to identify the day or days(s) he/she wants or do not want service. The calendar may be a traditional calendar, a list contains of days or combinations of days, a drop down menu contains of days or combinations of days or other forms. The server may also allow the user to enter from keyboard the day or days the user wants or does not want services.

The buyer can choose to set different routes, pickup points and pickup time for each day on the calendar as described in steps 112 138 (FIG. 2). Alternatively, the buyer may use a default route; pickup point or pickup time information as previously entered in steps 158 and 160. The buyer can modify the buyer's preference if the buyer desires at step 162. The buyer may set up the “occurrence rate” for each product to appear on the buyer's menu at step 164. Occurrence rate is the percentage of times an item appears on the buyer's total orders.

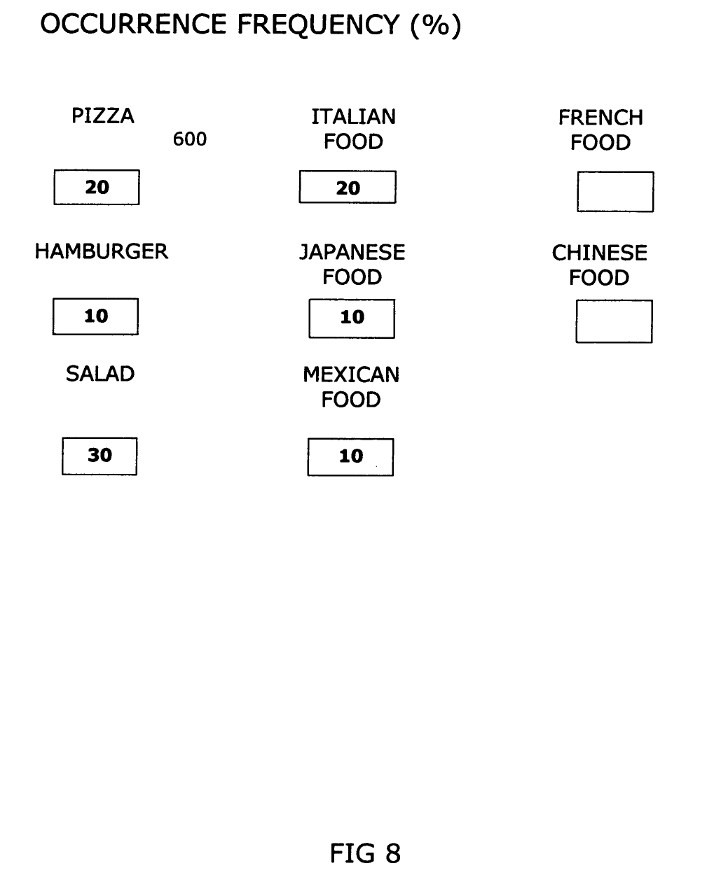

FIG. 8 is a sample template for a buyer to enter occurrence rates. An entry of a 20% occurrence rate for pizza 600 means the buyer wants 20% of the buyer's total orders to be pizza when the MPS server fills orders for him using ASM service. The MPS server can also be set up so that the same item will not appear twice consecutively.

Referring again to FIG. 1, the MPS server fills orders for the buyer according to the buyer's preference and occurrence rate entered at step 166. If no change is to be made about the orders, the buyer then decides if the buyer wants to place orders in other categories at steps 168 and 170. If the buyer wants to place an order in another category, the buyer goes to category selection at step 146 and follows the same procedure as described before. If buyer does not want to shop for any other categories, the buyer makes payments at step 172. The MPS server regularly checks buyer orders to see if there is any order or delivery that is due at step 174. If an order is due the MPS server prepares for production or makes inventory requisitions.

Referring again to FIG. 2, the MPS server collects buyer's names, pickup points, pickup times and other related information for due orders at step 176. The server first groups orders by buyer name at step 178. The MPS server may keep a total of all orders that have identical or nearby delivery addresses. The MPS server decides how physically close those addresses are to be qualified as “nearby”. A delivery address is part of the information a buyer inputs when a buyer enters their preferences. Delivery addresses are the addresses an MPS server will deliver products to, when the following circumstances occurs. The MPS server may decide that it is feasible for the MPS server to deliver products to a buyer at the buyer's physical address, (not deliver to a MPS pickup point for buyer to pickup, but deliver to the buyer's physical delivery address), if orders with the same or nearby delivery address are over a predetermined amount. Once the MPS server decides it is feasible to deliver, the MPS server sends a message to those related buyers notifying them that the products they ordered will be delivered to their delivery addresses. For buyers that agree to the delivery, the MPS server arranges the products to be delivered to them at their delivery addresses.

For those orders the MPS server does not deliver to a buyer's delivery address, the MPS server further groups those orders by pickup points at step 180. At this time, all orders are grouped by buyer name and by pickup point and are waiting to be shipped by MPS to MPS pickup points. The MPS server calculates the size of the load (orders) that needs to be shipped to the MPS pickup point and assigns a MPS with enough capacity to execute the shipment at step 184. The MPS, after being loaded with orders, is dispatched to an assigned pickup point at step 186. The MPS server can determine the timing of dispatching MPSs to pickup points. For example, if a MPS is needed at a pickup point at 4:00 PM and MPS server also determines that the time spent on travel from the MPS server's warehouse to a MPS pickup point is about 1 hour, the MPS server determines that the MPS should leave the MPS warehouse at about 3 PM.

A MPS server may send out a reminder to a buyer to remind the buyer to pick up the buyer's products at step 188. The reminder may be sent by e mail, a telephone call to a buyer's cellular phone or office, or by sending a message to the buyer's palm pilot. With a buyer who equipped with Mobile Location Determination System (MLDS), Global Positioning System (GPS), car navigation system, cellular phone caller location determination system or other systems capable of determining user's current location, the MPS server may, upon detecting that the buyer is near the buyer's pickup point, starting to prepare the user's order and/or send a message to the buyer to remind the buyer to pick up products ordered and give the buyer the directions to the pickup point.

When a MPS arrives at a pickup point, the MPS stays there for the station time at step 190 and waits for buyers to pickup products at step 192. In the case where the MPS is a locker kiosk without an operator or attendant, the station time may be longer then those stations with operators or attendants. The MPS may install a sign, fly a balloon, or turn on a search light for buyer's easy identification. Also, a MPS may have microwave ovens for the buyer's convenience in heating up food the buyer picked up.

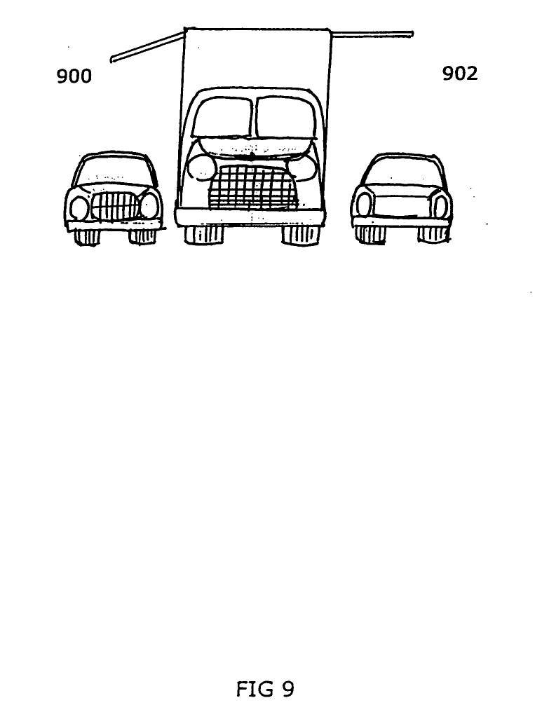

Referring to FIG. 9, a MPS may also install a panel 900. When the panel is pulled up to the panel's up position 902, the panel will shelter a buyer from the rain, snow, or sunlight. When in the case the MPS is a truck, the panel provides the buyer a “drive thru” lane. A buyer can thus pickup products ordered without leaving the buyer's car.

Referring again to FIG. 2, when a buyer picks up a product at step 192, the operator of a MPS, if assigned, may want the buyer to sign a receipt as evidence of receiving products. If buyer fails to pickup an order at step 194, the MPS operator may follow the buyer's instructions as how to handle the non-picked up products. A MPS server may give instructions such as: return those non pickup products to a MPS warehouse for re-delivery or sell the non-picked up products for whatever the operator can sell and credit the buyer for the amount sold etc. When the station time is up, the MPS leaves the MPS pickup point (or being picked up by MPS server) at step 196. The MPS station may leave the pickup point if all orders have been picked up even if station time is not up. For the maximum use of an MPS, it may be moved to another location to carry out other assignments at step 198.

If the buyer wants to order manually instead of using an ASM service to order at step 152, also if the delivery is not for the current day at step 153 and the selection of order is not complete at step 202, the MPS server provides a calendar at step 204 for the buyer to select the days of order/delivery desired. The buyer manually marks on calendar the days the buyer wants to order products and have it delivered at step 206, and the buyer fills those days with order at step 208. The buyer may specify a different route at step 210 and pickup time at step 212 for each day by using the same procedure as described before.

If the manual selection of orders is complete at step 202, the buyer makes decision as to whether the buyer wants to make other orders at step 170. If the buyer does want to make other orders, the buyer selects a category at step 146, if not, the buyer makes payments on the existing orders at step 172. If the buyer wants to order manually instead of using an ASM service at step 152, and if the order/delivery is for the current day at step 153, the buyer goes into the order mode and places an order at step 220. The buyer may change route, pickup point at step 224 and pickup time at step 226 as previously described.

In another embodiment of the present invention, the server may choose a selected-group, monitor the orders (or choices) of the selected-group and publish the orders (or choices) of the selected-group to give the user a reference when the user makes his/her purchase decision. The selected-group may be of any size determined proper by the server. The server may select the group members based on ethnic, income level, gender and other considerations that are considered representative of the target market the server wants to serve. The group members may or may not be the server's current users. As an example, the user selects a selected-group consists of a hundred of the server's current users, the server monitors the selected-group's purchasing behavior and finds that in the last week of July, 30% of the group ordered chicken a la king of brand A, 25% of the group ordered cheese burgers of brand B . . . etc. The server may publish this information to aid the user in making his/her purchase decision. The server may perform such monitoring and publishing daily, weekly, biweekly, monthly or at any other interval determined by the server. The server may build-in this selected-group purchase information as order selection criteria into the Automatic Selection Method (ASM). That is, if the user chooses to use this information as an order selection criteria when using Automatic Selection Method, the server may auto fill the user's order with the item most selected by the selected-group when the information becomes available. If the user has ordered the most selected item recently and the user does not want any repeated order, the server may auto fill the user's order with the second most selected item by the selected group . . . etc. The user may decide that if he/she wants these auto-fills be subject to the preference screening process as stated before.

When the user uses the Automatic Selection Method to have the server generate order for him/her, the MPS server may notify the user the server-generated order by e-mail prior to delivery to see if the user is satisfy with the order. The e-mail may contain other selections for the user to select if the user is not satisfied with the server-generated order. The user may e-mail back to the server the user's decision. The server then produce user order according to user feedback.

The server may allow the user to place different orders in the same day and may have those orders delivered to different pick up locations at different times of the day. For example, the user may order lunch and dinner on one day, and have the lunch delivered to pick up point A at 11:30 a.m. and have the dinner delivered to pick up point B at 5:30 p.m.

As previously described, after a buyer establishes the buyer's chosen route and defines a channel width, a MPS server presents available pickup points within or around the buyer's channel for buyer's selection. As described also, MPS server may present to the buyer available pickup points within the map defined by identifiers entered by buyer. Several different methods may be used by a MPS server to determine available pickup points for the buyer's selection.

It is apparent that it is to the benefit of the MPS server to select pick up points at locations where maximum amount of users travel by. An approximate method may be used when the MPS server does not have enough information about buyers' chosen commuting routes to establish a buyer route distribution within a region. The MPS server may then use traffic volume on a route (i.e. a highway or a street) on a highway or a street in a region as a guide to approximate buyer route concentrations and place available pickup points along the route the highway or street for buyer selection. A highly traveled highway may be assumed to have a high user route concentration. The same assumption may be made for a busy major street. The MPS server may thus present to the buyer pickup points along those routes. Other criteria in determining available pickup points may be considered and will be disclosed later.

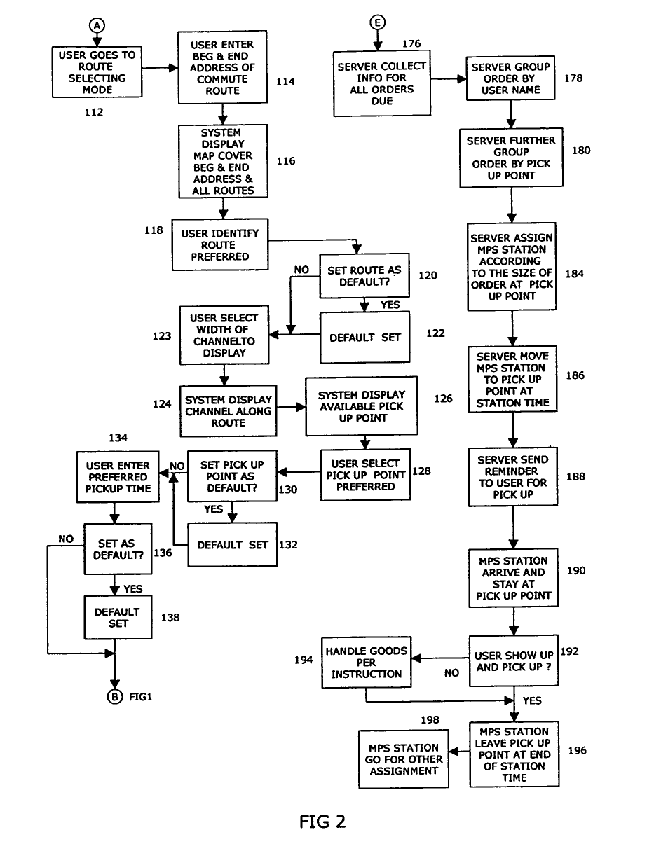

FIG. 3 is a process flow diagram of a method used by a MPS server for selecting pick up locations using an overlap route method. In this method, the MPS server collects buyer chosen commute routes and/or channels from buyer input at step 300. The MPS server then overlaps all chosen routes without channel or all channeled chosen routes defined by all buyers at step 304. The MPS server may for every overlapped route or area select the overlapped route or area as an area for available pickup points at step 306. In addition to overlapping, the MPS server may consider other criteria at step 308. Other criteria the MPS server might consider are: is rent involved for using a pickup point? How much is the rent? Is the pickup point far away from the buyer's route? Is the pickup point convenient to get access to from a buyer's route? Is parking sufficient? Is the pickup point easy to identify etc. The MPS server makes a decision and selects available pickup points at step 310.

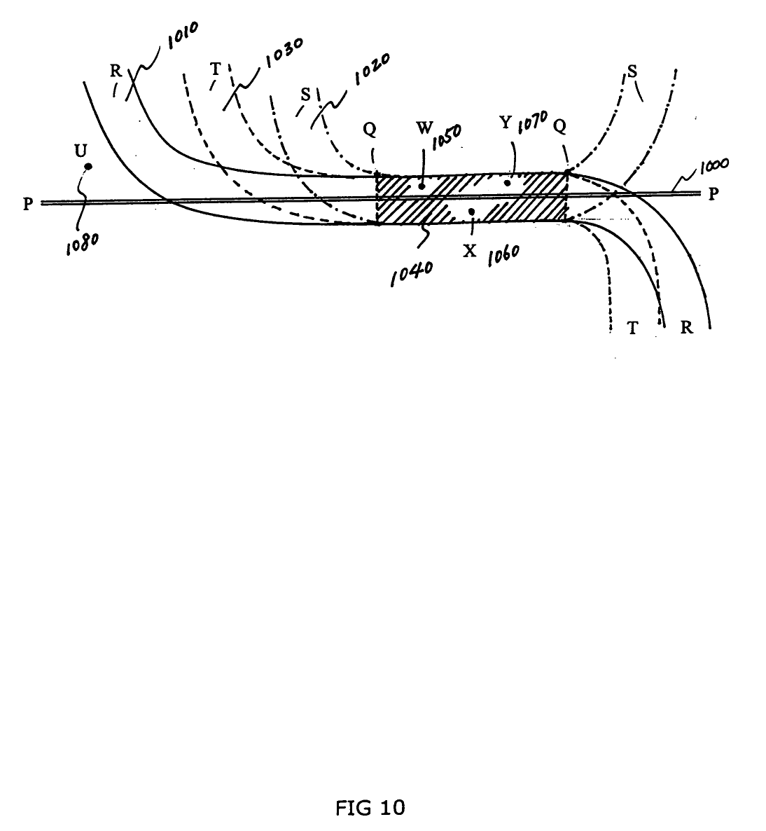

A buyer chooses a buyer's chosen pickup point and/or default pickup point among those available pickup points provided by the MPS server. The MPS server decides if current available pick up points would be able to satisfy users at 312? If it is, the selection of available pick up points is complete and goes to step 314. If the MPS server needs to provide more pickup points to the buyer, the MPS server goes to step 308 for more selections. The MPS server may change parameters to expand or contract the area of available pickup points at step 314. For example, the server may decides that it is no longer economically feasible to select an area to establish available pick up points if the area only contains a few user route/channel overlaps. The server may increase the parameter. From time to time, the MPS server may periodically review buyers' chosen commuting routes at step 316 to see if buyer route distributions have changed. If buyer route distributions have changed, the MPS server can correspondingly reposition its pickup points to better serve buyers. If the time for route reviewing is due at step 318, the MPS server starts the whole process all over to update the MPS pickup point positioning at step 300. FIG. 10 is a graphical representation of a MPS pickup point area assessment. Assume that PP 1000 is a route, e.g. a highway or a major street with heavy traffic. Buyers R, S, and T each have a buyer's chosen route. Buyer R has chosen route RR 1010, buyer S has chosen route SS 1020, and buyer T has chosen route TT 1030. Also assuming in the beginning, a MPS server does not have any route information pertaining to buyers R, S, and T, then the MPS server can only use an approximate method to choose a pickup point, for example, point U 1080. Under this method, buyers R, S, and T have to travel out of their chosen channels to get access to point U.

Now assuming the buyer routes are available to the MPS server. The MPS server overlaps all chosen channels from for all of the buyers to form an overlapped area QQ 1040. Area QQ will be qualified as a pickup point selection area because QQ is the area overlapped by multiple chosen routes, namely RR, SS, and TT. The MPS server may propose pickup points within this available pickup point selection area QQ to a buyer wishing to pickup a product.

Now assume that points W 1050, X 1060, and Y 1070 are locations inside area QQ that the MPS server considers as possible pickup points. Also assume that point W is a parking lot in a major super market, W is also close to route PP and easily accessed from route PP. The MPS server selects W to be a pickup point after the MPS server considers all criteria. Point W is then presented to buyers R, S and T and W can be chosen as a pickup point. A buyer may then abandon their original pickup point U and position the new pickup point at W. The MPS server may propose more than one available pickup point in an available pickup point selection area depending upon buyer route concentration, e.g. X or Y may be selected as available pickup points also if the MPS server desires.

In another embodiment of the present invention, the MPS, may be a vehicle, a kiosk or a trailer, is equipped with refrigerator(s) or food heating device(s) to carry or store food products. The MPS may further be equipped with microwave oven(s) and is capable of heating up or cook the foods carried ordered by user/recipient. The MPS may further be equipped with other food cooking equipment(s) and supplies that allows the operator(s) of the MPS, e.g. the driver and/or helper, to cook (or prepare) food in the MPS. The MPS may be equipped with one or more of the following cooking equipments and supplies: stove, oven, microwave oven, sink, refrigerator, cookware, water supply, gas supply, water tank, package material, sanitary equipment . . . and other equipment and/or supplies that may aid a MPS operator(s) to perform food cooking or preparation functions. The MPS may further be equipped with facilities such as toilet(s), first aid equipment(s), fire extinguisher(s) . . . etc that may accommodate the need of MPS operator(s) when stations at the MPS pick up point. The MPS may be also equipped with telephone(s), computer(s), wireless transmitter(s) and/or receiver(s) so that it can communicate with MPS server, get access to the Internet, get access to MPS Intranet or communicate with other parties. In an exemplary use of the present invention, a MPS server is a food service provider, e.g. a caterer or a restaurant. A user/customer uses the service provided by MPS server to order food and select preferred pick up location for pick-up as described. The server then collects all the user orders, groups these orders by user names and by pick up locations. The MPS server loads these grouped orders to the corresponding MPS station and dispatches the MPS station to its assigned pick up location waiting to be pick up.

Another embodiment of the present invention involves a system of preparing and scheduling of user orders by the server after users determine the users' preferred pick up points. When preparing user orders, the MPS server may fully cook (or prepare) the user order, partially cook (or prepare) the order in its central kitchen before loads these orders to a MPS. User orders may be uncooked when loaded to a MPS. The server loads the MPS with user orders and dispatches the MPS to its assigned pick up location. The server makes decision to fully cook, partially cook or uncooked user order according to the nature of the order. For example, the server may fully cook/prepare orders such as garden salads, chicken salads, cold cut sandwiches, sashimi or chicken noodle soup . . . etc and pack those foods to ready in its central kitchen before loads these orders to the MPS. The food orders then are stored in the refrigerator or heater in the MPS and are transported to their pick up location. The MPS server may partially cook/prepare some of the user order such as chicken a la king, prime rib, roast beef, crawfish etoufee . . . in the central kitchen then loads it to the MPS and shipped to MPS pick up location. The MPS operator may further cook or microwave these partially cooked orders in the MPS its ready to consume condition during the time the MPS is been dispatched to its pick up location. Or, the operator may further cook or microwave the order to its ready to consume condition when parking and waiting at the pick up location. Alternately, the operator may further cook or microwave the order its ready to consume condition just before the estimated time of user (or recipient, termed user herein even they may be different parties) arrival or at the time of user arrival when parking and waiting at the pick up location. In the present invention, the term partially cooked orders means orders are cooked but not to their ready to consume condition.

The server may keep orders such as fried chicken, French-fries, pizzas . . . etc, uncooked when loads these orders to the MPS. The MPS is then dispatched to and waits at the pick up location. The operator waits until the estimated user arrival time is up or until the time the user arrives at the pick up station then starts to cook. The user order may be a combination of fully cooked orders, partially cooked orders and uncooked orders. The MPS operator may, after these partially cooked and/or uncooked orders are prepared, packs them with cooked orders then hands the complete package to the recipient at the time of the recipient's arrival.

The package volume of an order at its final packaging stage may be larger than the total storage volume of all the items in the order stored individually. For example, a buyer goes to MacDonald's and orders a Big Mac, the cashier in the MacDonald's puts the Big Mac into a bag along with utensils and other supplies. The total package volume at the final packaging stage (when the Big Mac is packed inside the paper bag with utensils, supplies . . . etc.), is much larger than the total storage space needed for all its component items when stored individually. Thus, in order to save storage spaces, the operator of MPS may stack up all orders (fully cooked, partially cooked or uncooked) in their raw package forms, and waits until the time the user comes up then put all user order items in a bag or container and complete the final packaging.

The server may schedule the timing of preparing (or processing) user orders for the MPS operator(s) to follow. Because a user tends to arrive at the pick up point at about the same time every day, the MPS server may determine a user's usual arrival time at the user selected pick up point. The MPS server may also determine the time the MPS operator needs to prepare and complete each user order in the MPS. Based on this information, the MPS server may produce a working schedule for the MPS operators to follow in preparation of user orders.

The server may use the following procedure to determine the user's usual arrival time at the pick up point. The MPS operator collects the time of user arrival at the pick up point each time the user arrives. The operator then sends these records to MPS server. The MPS server keeps and compiles those records to determine the user's usual arrival time. Or, the server may ask the user to enter the user's preferred pick up time during user registration and use the user input to determine user's usual arrival time. Once the usual arrival times of all users and the preparation time of all user orders are determined, the server may prepare a working schedule for the MPS operator to follow for the preparation of user orders. The MPS operator(s) then prepares/cooks user orders according to the schedule.

The server may delegate to the MPS operator to produce the operator's own working schedule by using this information.

Besides using projected user arrival time as a base to prepare user order, there are other timing methods used by an MPS operator to prepare or cook user orders. Such as:

a) The user may call or communicate to the MPS operator by phone, Internet, palm pilot or any other communication means to notify the MPS operator of the user's arrival time at the MPS pick up location. The MPS operator then use the communicated arrival time as user arrival time together with the user order preparation time to determine the timing of preparing user orders.

b) User and the MPS server may install devices that utilize location determination technique, such as Mobile Location Determination System (MLDS), Global Positioning System (GPS) or car navigation system . . . etc. A tracking device installed with the user along with the device installed with the MPS server may allow the MPS operator (or the MPS server) to detect the user's current location and/or traveling directions. The MPS operator (or the MPS server) may periodically update the user's current location information by using these technologies and use this information to estimate the time of user arrival and prepare the user's order accordingly.

c) User order is prepared at the time of the user's arrival at the pick up location. This approach is suitable for orders that require a short amount of time (or no time) to prepare by a MPS operator to its ready to consume condition. As an example, assuming a user's order is chicken noodle soup, the server may fully cook the order in its central kitchen and stores the order in the MPS refrigerator. The order is cold when user arrives. Because it would take only few minutes to heat it up, the operator may wait until the user arrives, then heat up the order and give it to the user/recipient. This approach is also suitable for orders that require immediate consumption after preparation, such as French fries, fried chicken . . . etc.

d) Some of the user orders may be prepared or partially cooked to a stage that it would only need a limited amount of further heating or preparation to have it ready. These further heating or preparation may be easy enough for the user to do it himself/herself. If a user wants to take these orders home and do this further heating/preparation personally instead of having MPS operator to do it, the user may so indicate when he/she places order. The MPS operator may hand these orders over to the user at his/her arrival without further preparation.

Handling instructions that contain packaging and storage information and other information such as cooking time and temperature needed . . . etc may be attached to the outside of user orders.

The cooking equipments in a MPS station may be removable and/or replaceable. For example, a refrigerator may be replaced with an oven in case more cooking activities are needed in the MPS station and less storage space is required.

Besides preparing food, the operators of a MPS may help or direct the recipient who comes to the pick up point to park. Also, the operator may bring the order to the side of recipient's vehicle so that the recipient does not have to leave his/her car to receive his/her order.

In another embodiment of the present invention, the server institutes a system to handle Special Orders (SOs). Special Orders are these orders placed by existing or new users, due to the timing of placing orders or decision from the MPS server, are transferred to a MPS station for production in the MPS station. Most Special Orders are these orders received after order cutoff time. Because it takes time to have an order ready in the central kitchen after the server receives it, the server may set up an order cut off time. Orders received after the order cut off time will not be prepared in time in the server central kitchen before the dispatch of the MPS. An after-cutoff-time order can only be produced in a MPS station. The MPS server may estimate the amount of SOs and let a MPS to carry an estimated amount of inventory to satisfy the estimated SOs. SOs are routed to a MPS for production/preparation.

MPS server may institute the following procedure to handle Special Orders: The user goes on line to MPS web site with devices capable of getting access to the internet and places order. If order is placed after order cut off time, the order is a SO. Some times, even if the order is placed before order cut off time, the server may decide to let individual MPS station to process/produce user orders instead of having the central kitchen to do it, the MPS server may treat the order as a SO. If the user order is a SO, the user is transferred to Special Order Processing Mode (SOPM). Then, the order is produced in the MPS station. Further, in SOPM, the user is allowed to identify his/her current physical location. The user may do so by entering his/her current physical location address, crossing streets, city names, major landmark or other location identifiers. Or, the user may click on the map presented to him by the MPS server to identify his current location. The user may also enter his/her driving direction (if needed), driving speed (if needed) and his order. The system identifies the item(s) in the user order and determines the time needed to complete the order. The server then searches for MPSs that carry the inventories needed to fill the order. A MPS communicates constantly with the MPS server thru wireless communications to report to the server the current level of on hand inventories and the capability of accommodating new orders. Also, because the MPS is mobile in nature, the MPS needs to constantly report to the server its current location. The MPS server uses a MPS's on hand inventory, producing time for the order, the user's current location and the user estimated traveling time to arrive at a MPS station as factors to determine which MPS station would be selected as a candidate to handle the user order. For example, the MPS server estimates that it would take 5 minutes to produce and complete the user's order, thus, any MPS station with needed inventory on hand and is over 5 minutes driving distance away from the user's current location, would be a candidate to handle the user's order. If no MPS station with needed inventory is over 5 minutes driving distance away, and if the user is willing to wait for the preparation of his/her order, the one with needed inventory may be selected as a candidate. If no MPS carries the needed inventory to produce user order, the user is asked to change his/her order and the MPS starts the search process from the beginning. The MPS server presents to the user the locations of all MPSs that are candidates to produce user order to allow user's selection. If the user enters his traveling route identifier(s) to identify his/her traveling route and if the user also identify his/her current location, the MPS server may display all MPSs that are candidates to produce the user order and are defined by the user route. The user may select among those candidates the MPS (or the MPS pick up location) he wants to pick up his order. After all other needed administrative details, such as payments., have been taking care of, the server issue production order to the selected MPS for the production of the user order. Also, the server may communicate to the MPS station about the user's expected arrival time and other information, such as information needed to identify the recipient . . . etc. The server then notifies the user (or recipient) to pick up the order at the selected pick up location. A user may use this approach to modify his regular order if the change of regular order is initiated after order cut off time and is then classified as a SO.

In another embodiment of the present invention, the MPS server may select to display or block some contents of a selection Web page displayed to users depending upon the place the user lives or the route or locality identifiers the user selects. This option is important and can be illustrated by the following example: Assuming a chain restaurant joins the MPS delivery service and user may order and receive the chain restaurant's food thru MPS ordering and pick up service. The chain restaurant may wish to block access to users that live close to (or commute thru) a chain restaurant franchise location from using MPS service to order the chain restaurant's food. This is so that the MPS service will not cannibalize the business of the regular chain restaurant's franchise. The chain restaurant may then select an area (or zip code or city) and order the MPS server to block users that live in the area (or commute thru the area) from ordering the chain restaurant's food thru using MPS service. The MPS server then display the web page to these users without the chain restaurant on it. In contrast, the chain restaurant may select an area (or zip code or city) that chain restaurant may wish to promote its business thru MPS service and wants the MPS server to display its food to those users living in the area (or commute thru the area).

In another embodiment of the present invention, the MPS server institutes a system that allows the user to use MPS service even if the user does not have the ability or does not want to get access to the Internet. In this embodiment, the user uses a telephone or a cellular phone to call a MPS phone operator and the phone operator acts as a mediator between the user and the Internet (or the MPS Intranet). The MPS phone operator, who has the ability to get access to the Internet or the MPS Intranet, receives the phone calls, goes to the MPS web site while verbally communicating with the user. A new user may communicate to the MPS phone operator through a phone all information needed to receive MPS service, e.g. information needed to register, to set up an account, to establish user preferences, to select a route, to select a pick up location, to place orders . . . etc. The phone operator inputs this information into the MPS system and helps the user to get access to an MPS service. An existing user may uses a phone to tell the MPS phone operator his account number, access code or other information needed to get access to his account, again, the phone operator input these information and help the user to use MPS service. In this approach, the user may still access to the full and all services provided by the MPS server, e.g. defining of route, selecting of pick up point, selecting of products and delivery services . . . etc, like an ordinary internet-accessing user. The difference is that the user gets access to MPS service through a MPS phone operator. The MPS phone operator has the ability to get access to the Internet or to the MPS Intranet. Because the user cannot visually see the image of product ordered, the map that displays available pick up points, the distribution of available pick up points and/or other information that is normally presented to the user on a screen, the MPS phone operator has to verbally communicate and describe this information to the user. This approach may greatly improve the service of MPS. As an illustrative example, a user, who is on the road, did not place order with MPS server in his office and a device that may get access to the Internet is unavailable. The user may still call the MPS phone operator, place order and use MPS service.

In another embodiment of the present invention, where again the Internet access is not available or not preferred by the user, the user may use phones (telephones or cellular phones) to place orders and to select pick up locations. In this embodiment, catalogs (or brochures) are sent to users. The catalog (or brochure) contains information such as server's telephone number, products sold and price of products. The catalog or brochure also contains available pick up locations information. As described, the user may select preferred pick up location and pick up his/her order at the location. The catalog may contain maps that cover areas defined by cities, counties, area codes, zip codes or other locality identifiers. The user may select an identifier as key and goes to the map identified. In the map, all available pick up points are displayed for the user's selection. The user selects pick up locations to where he/she wants the order to be shipped. In the case where map presentation is not used, lists that contain all available pick up locations within the areas defined by locality identifiers are presented to the user. Catalogs (or brochures) are updated periodically and are sent to users. Codes or names are assigned to available pick up locations and products sold in the catalog for easier identification. In operation, user calls the server and communicates to the server's phone operator information, such as name, account number, credit number . . . etc, needed to place order. The user also tells the phone operator the day(s) the user wants orders/services, the product codes (or products) the user wants to order, and the pick up location code (or pick up location) the user wants his order to be delivered to. If the user chooses to use the Automatic Selection Method (ASM) to let the system auto-fills orders for him/her according to the day(s) of service selected, user's preference and occurrence rate selected, the user, may communicate to the operator the day(s) the user wants service, the user's preference and occurrence rate for his/her order. If the user does not want to use the ASM method may fill his/her order by telling the operator directly the day(s) of order and the order(s) for the day(s) the user wants. The server then, according to this information, prepares the user's order. The server then groups user orders by pick up locations and by names, loads grouped orders to a MPS, ships the user order to the user selected pick up location and waits for the user/recipients to pick up. In the present invention, whenever phones (telephones or cellular phones) are used by users to communicate to the server, voice activated telephony technology that recognizes user spoken languages may be used to link to the server system to replace humane operators as long as the communication between the users and the server is effective. The phone system in the present invention thereby includes the phone system with operators and/or system with voice activated telephony technology.

The MPS server may be in affiliation with Brand-Name Food Providers (BFP) such as Red Lobster, Chili's, Mimi's Café . . . to incorporate the BFPs' products into MPS delivery service. A BFP is a food service provider who sells its food products using a brand not belong to the MPS server.

In another embodiment of the present invention, the MPS server and BFPs, through arrangements, located with each other in one building, one location, one compound so that the MPS server may conveniently incorporate the BFPs' products into MPS delivery function. That is, thru such arrangement, the MPS server may conveniently collect all BFPs' products in the MPS central kitchen/warehouse, process these products and load these orders to corresponding MPS stations and dispatch these MPS stations to MPS pick up points. The arrangements between the MPS and a BFP may be: the MPS server lease spaces of its central kitchen to the BFP(s) or vice versa. Or, the MPS may co-own the central kitchen with a BFP(s). All the methods, processes and procedures disclosed in the present invention that may be used by MPS users and applied to orders of MPS users may also be used by BFP customers and applied to the orders of BFP customers. Note that in this embodiment of the present invention, it is possible for a user to place different orders to different BFPs that are affiliate with MPS server and conveniently receives all orders at once. For example, the user may order steak from restaurant A and seafood platter from restaurant B and receive all orders at once when he/she arrives at the pick up point the user selected, assuming A and B are all in affiliation with the MPS server as BFP members.

The MPS server may designate a section of its web site to every BFP the MPS server is affiliate with. Or, a BFP, may, in its own web site, provide its customer an option to use the MPS delivery service to pick up orders. An icon may be presented to the BFP's customer. After a user completes his/her order at the BFP's web site, the user may click the icon. The order is processed and is transmitted to the BFP's staff at MPS central kitchen for production. The ordering process, termed third party ordering, will be disclosed further later.

The MPS server may operate its business model by 100% in partnership with BFPs without its own brand name, 100% use its own brand name without in partnership with any BFP or in partnership with some BFPs and at the same time develops its own brand name.

In another embodiment of the present invention, the MPS server may prepare all partially cooked orders in its central kitchen to a stage that needs a specific time, e.g. two minutes, to further cook or prepare to their ready to eat condition. The further cooking time, e.g. two minutes, is determined by the MPS server and will be applied to all partially cooked items. The advantage of this process is that it would be systemic and easier for the MPS operator or user/recipient to remember and prepare these partially cooked items.

In another embodiment of the present invention, a MPS server acts as a third party delivery MPS server. A third party is a business entity other than the entity providing the MPS server itself that has an agreement with a MPS server to use a MPS server services to serve the third party's customer. For example, a local flower shop may receive orders on line from a buyer. The flower shop allows the buyer to access a MPS server operated by an entity other than the flower shop so that the buyer can use the MPS server to position a pickup point and pickup flowers ordered there. This flower shop is a third party seller.

Sometimes a third party seller's customer may already have a preferred MPS pickup point established with a MPS server because of previous orders with other companies. In this case, the third party seller only needs to confirm that the buyer wants to use the MPS service to pickup flowers ordered, the flower shop then makes arrangements with the MPS server so that the flower ordered may reach the pickup point for the buyer to pickup. The arrangements between the third party seller and a MPS server with regards to the shipment of products from the third party seller to a MPS warehouse may take many forms and will be discussed in more detail later.

Upon receipt of the third party's products, a MPS server searches to see if the buyer has other orders that can also use MPS service. If the buyer does have other orders, the MPS service groups all orders pertaining to the same buyer and uses a single MPS to deliver those products to a MPS pickup point for pickup by the buyer.

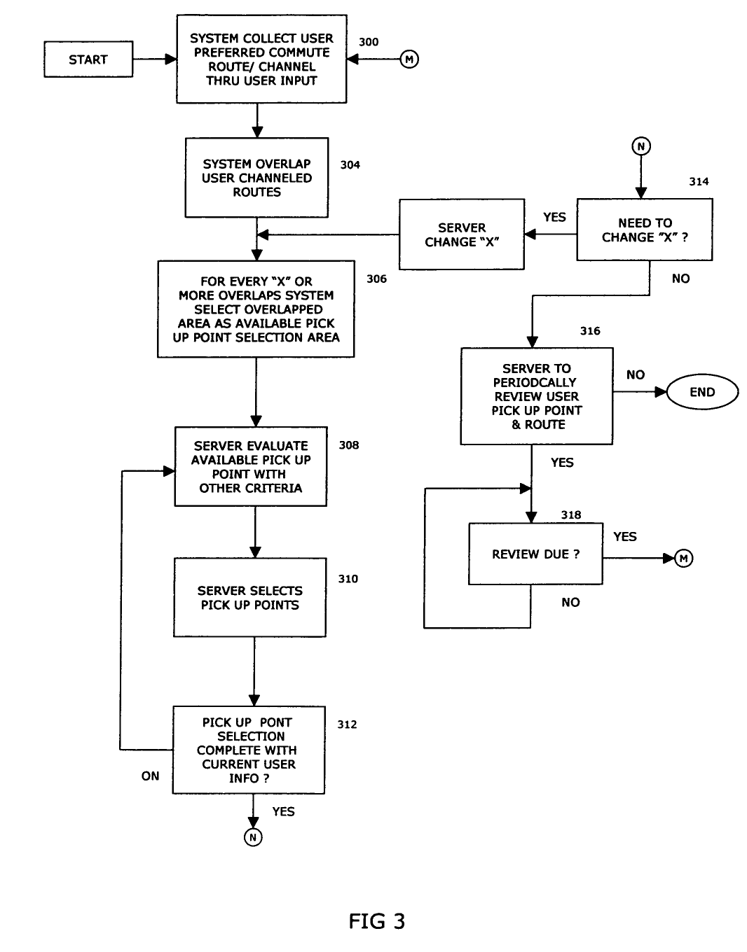

FIG. 4 is a process flow diagram of a third party seller ordering process. A buyer goes on to the Internet at step 400, and goes to a third party's Web site at step 402. The buyer makes orders at step 404, the buyer then makes decision as to what delivery options the buyer will use at step 406. The buyer decides if the buyer wants to use conventional delivery methods to ship the buyer's order, which usually involves shipment by common carriers (e.g. by UPS or US Post Office), or uses MPS pickup MPS server so that the buyer can pickup the buyer's order at a pickup point. Assuming the buyer wants to use a MPS service, the buyer goes to a MPS server Web site at step 408.

At the MPS server Web site, the buyer either sets up to establish a pickup route and pickup point with the MPS server or updates route and pickup point information already established with the MPS server from previous purchase with the MPS server at step 410. The third party seller keeps a record of the buyer's order together with all related shipping information.

The third party seller may establish an order cut off time, which is the latest time for order receiving. An effective cut off time allows the seller enough time to pack and arrange ordered products to be shipped to a MPS warehouse before a MPS server dispatches to MPSs to pickup points. For example, assume a MPS leaves a MPS warehouse then heading for a MPS pickup point at 3:30 PM. Also assume that it takes 30 minutes for the seller to process and pack orders and it takes another 30 minutes for the products to be shipped to the MPS warehouse, the order cut off time will be set at 2:30 PM. If a buyer orders before cut off time at step 414, the third party seller then arranges the ordered products to be shipped to the MPS warehouse at 418.

There are various ways products can be shipped to a MPS warehouse, which will be disclosed later. Once ordered products are shipped to a MPS warehouse, the products are loaded on to a MPS and then the MPS moves to a MPS pickup point at step 420 and waits for buyers to pickup up products at step 422.

In the case where a buyer orders after the cut off time of 2:30 PM, as set in the above example, the third party seller may impose an extra delivery fee to deliver the order to a preferred pickup point and the buyer can pickup the buyer's order at that pickup point. In this case, the third party seller logs on to a MPS server. The MPS server displays a map that covers the third party seller's location and the buyer's route at step 424. The MPS server also displays the buyer's default pickup point and other available pickup points near the route. The seller selects a pickup point for delivery at step 426 and quotes the buyer the price of delivery to that pickup point. If buyer agrees with the quotation and other terms at step 428, the products are delivered to that specified pickup point for buyer to pickup at step 422. If no pickup point is satisfactory to the buyer, other arrangements have to be made at step 436 or the sale is cancelled at step 434.

As previously discussed when discussing step 418 of FIG. 4, various arrangements for the shipment of products from a third party seller's store to a MPS warehouse may be made. These arrangements may take many forms.

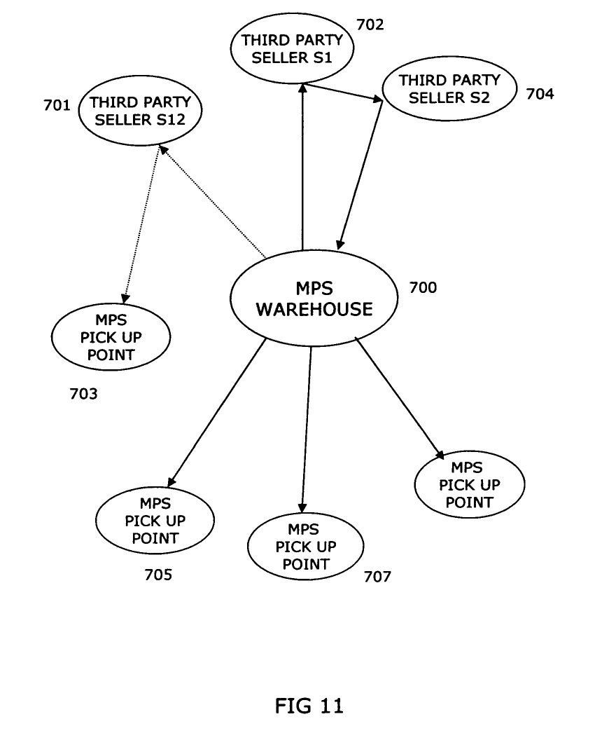

In one embodiment of a MPS server, as illustrated in FIG. 11, a MPS warehouse 700 sends out transportation equipment, e.g. MPSs, to the warehouses of a third party seller S1 702 and a third party seller S2 704 to pick up products ordered by buyers. The MPSs then go back to the MPS warehouse for packing and processing then are dispatched to pick up points such as 705 and 707 with user orders loaded. Or, the MPS may, after picks up orders from a third party seller (e.g. S12 701), goes directly to the assigned pickup points 703 for user to pick up goods users ordered.

S1 702, S12 701 or S2 704 may be one of the many stores that are affiliated to or owned by a large organization, e.g. McDonald's. In such a case, an arrangement may be made when a user places an order through MPS sever and calls for a product of such an organization, e.g. McDonald's. The server may use the user selected pick up point as a base to choose a participating McDonald's that is near the user's selected pick up point and passes user order to the participating McDonald's store.

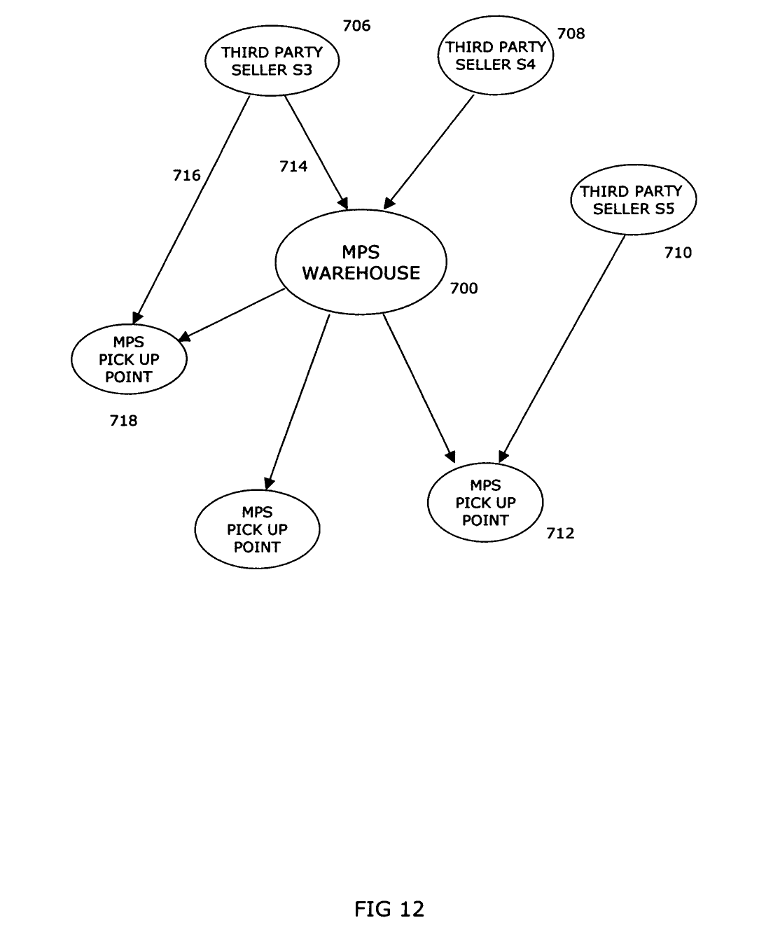

In an alternative embodiment of a MPS server, as illustrated in FIG. 12, a third party seller S3 706 and a third party seller S4 708 ship buyer ordered products to a MPS warehouse 700 by their own transportation means or by common carriers for further distribution. S5 710, another third party seller, which is local to one of the pickup points 712, may choose to ship buyer ordered products directly to the pickup point 712. A MPS that stays at pickup point 712 receives the products and waits for a buyer to pickup the products. Third party seller S3 may use route 716 to deliver a portion of orders directly to a pickup station 718 and at the same time deliver another portion of orders to the MPS warehouse 700 for further distribution. S5 710 may be one of the many stores that are affiliated to or owned by a large organization, e.g. McDonald's. In such a case, an arrangement may be made when a user places an order through MPS sever and calls for a product of the organization, e.g. McDonald's. The server may use the user selected pick up point as a base to choose a participating McDonald's that is near the user's selected pick up point and passes user order to the participating McDonald's store.

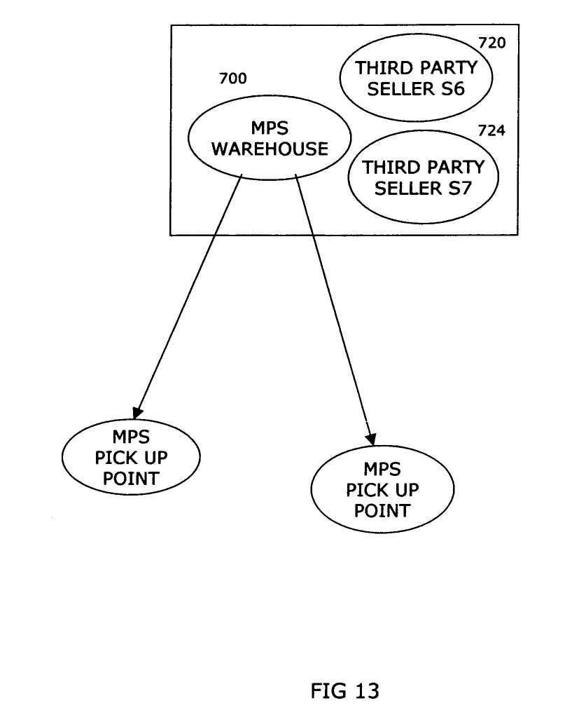

In another alternative embodiment of a MPS server, as illustrated in FIG. 13, third party seller S6 720 and third party seller S7 724 can be at the same location with a MPS warehouse 700. The third party sellers may be different entities that share the same warehouse or they may be different divisions that belong to the same entity. In this model, because the third party sellers are so closely located to each other, the order cut off time can be close to the time MPSs are dispatched to pickup points.

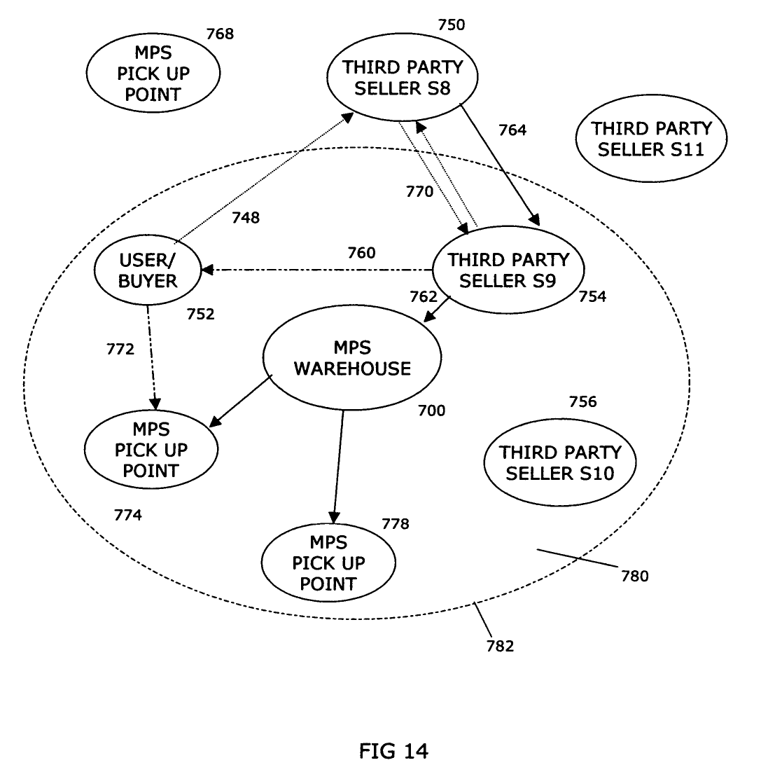

In another alternative embodiment of a MPS server, as illustrated in FIG. 14, third party sellers loan each other products to ease short term deficiencies in product supplies at a buyer's location. Assume that a third party seller S8 750 is a distant third party seller away from a MPS warehouse 700. A distant seller is a seller that is located far away from a MPS warehouse that serves a buyer. A seller S8 750 receives an order from a buyer 752 via the Internet or by other means 748. Assuming a third party seller S9 754 and a third party seller S10 756 are affiliates to S8 and each has an inventory loan agreement with S8. Third party sellers S9 and S10 may be related or unrelated business entities, or strategic partners to third party seller S8. Or third party sellers S9 and S10 may simply be warehouses owned by and apart from S8. For the purpose of this case, third party sellers S9 and S10 may be any kind of entities as long as third party sellers S9 and S10 have inventory loan agreements with third party seller S8.

In this case, third party seller S8 receives an order from a buyer and contacts third party sellers S9 and S10 to see if third party sellers S9 and S10 carry the same products as the products the buyer ordered. Third party seller S8 finds third party sellers S9 and S10 by using a search method called “Territory Search Method” to be described. Third party seller S8 then checks to see if third party sellers S9 or S10 can loan the item to third party seller S8 by shipping to the buyer the identical products the buyer orders. If both third party sellers S9 and S10 carry the ordered products, third party seller S8 proceeds with the loan transaction arrangement with the third party seller who would charge third party seller S8 the least. For example, if third party seller S9 is willing to proceed with a loaner transaction with third party seller S8, third party seller S9 ships a product the buyer ordered to the buyer's previously described delivery address or to the buyer's previously described preferred MPS pickup point based on the shipment method the buyer prefers. At this point third party seller S8 owes an identical product to third party seller S9. To perfect and secure the transaction to be an inventory loan transaction between third party sellers S8 and S9, agreements 770 between third party sellers S8 and S9 should be maintained. Such agreements may include provisions such as: third party seller S9 will be paid back by receiving the identical products from third party seller S8 only; third party seller S9 is paid a processing fee for the loan arrangement; third party seller S9 will not be paid for the products loaned by money; third party seller S9 does not receive any exchange for other products from third party seller S8; third party seller S9 will ship products to the buyer only after third party seller S9 receives a confirmation from third party seller S8 stating that identical products have been shipped to third party seller S9; and third party seller S8 is the party solely responsible for the quality of products shipped and any related customer seller dispute will be resolved between third party seller S8 and the buyer. In a product loan transaction, third party seller S9 never sells any products and keeps the same amount of inventory on the buyer's book. In reality, the buyer may not even realize that third party seller S9 exists. Any legal arrangements that may deal with title, risk, responsibility, insurance or others, as long as it will make this transaction a sale between the buyer and third party seller S8 and not a sale between the buyer and third party seller S9 will be instituted.

After third party seller S8 750 receives an order 748 from the buyer 752, and after the third party seller S8 and the third party seller S9 754 have secured an inventory loan agreement 770, third party seller S9 ships the products ordered to the buyer. Third party seller S9 may ship directly to the buyer address by common carrier 760, or by a MPS server 762. Third party seller S8 returns 764 the products loaned to third party seller S9. Assuming the buyer wants to use a MPS service, the buyer picks up the order at MPS pickup point 774.

Of course, as long as both parties agree, third party seller S8 may pay off third party seller S9 for the products loaned by paying money rather than delivering an identical product to S9. Such a payment, however, may cause third party seller S9 to recognize a sale. Also, if third party seller S9 is a distant warehouse and owned by third party seller S8, third party seller S8 may instruct third party seller S9 to ship products the buyer ordered (either to the buyer by common carriers or by a MPS service) without an inventory loan agreement. In this case, third party seller S9 may have to recognize a sale with the buyer especially with interstate transactions.

One embodiment of a MPS server provides for a channeled route search method in which the MPS server utilizes the commuting route and channel building technique previously described to carry out searches for products buyer wants to purchase. For example, a buyer wants to buy a car battery; the buyer goes to the Internet and logs on to a MPS server in search mode. The MPS server displays a map. A buyer may click or depress and drag the buyer's mouse on the map to define a route. The buyer may further define a width of a channel to form a channeled route and search within this channel for stores that carry the products the buyer wants to purchase.

Referring again to FIG. 7, the buyer through clicks or drag of mouse defines route 570. Assuming the buyer wants to search for a store with ¼ mile distance along the buyer's commuting route, the use sets a channel width size of ¼ mile. The MPS server displays a channel 572 with boundaries 578, 580. Each boundary is ¼ mile apart from the route 570. The MPS server will later search to see if there are any stores within the channel that carry the product the buyer wants. The MPS server accesses a database that contains stores with information such as: name, products carries, product price, address (with zip code) and telephone number etc.

The MPS server first determines all the Zip Codes that are covered by the channel. A zip code is covered by the channel as long as any portion of the zip code area is within the channel. For example, zip codes 92001 and 92003 are covered by channel 572. Zip code 92005 and 92009 are not. The MPS server goes to a database to search for all stores that carry car batteries and also with zip codes 92001 or 92003. All the car battery carrying stores with zip codes 92001 or 92003 are selected for the next test, and those stores with other zip codes, e.g. 92005 or 92009, are disregarded. If no stores are found in this search, the buyer may change the width of channel or change the buyer's selected route to launch another search. If there are stores that carry car batteries with channel matching zip codes (i.e. with zip codes that match 92001 or 92003), the MPS server saves these stores in memory and goes to the next step.

The MPS server searches for all the street names covered by (or within) the channel. Any street name or avenue name is covered by (or within) the channel as long as any portion of the street or avenue is inside the channel. For example, the channel covers Texas Street 592 and also Robinson Ave 594. MPS server compares all the street names within this channel to the street name of those stores with matching zip codes selected from above step. At this stage, all car battery carrying stores, with matching zip codes and with street names matching any of the street names within the channel are selected for the next test and the others are disregarded. For example, after the zip code test, all stores with street names such as “Hawthorn Street” 582 are disregarded and all stores with street names such as “The 31st Street” 584, Texas Street 592 or Robinson Ave 594 are selected for the next test. This is because Hawthorn Street in not covered by the channel and 31st Street and Texas Street are. Again, if there is no match found, the buyer can either enlarge the width of channel or change the buyer's commute route to launch another search.

If there are stores that match the above tests, the MPS server goes to the next step. The MPS server, after the buyer defines the width of the channel, can determine the street numbers (or street addresses, as sometimes called by people) at the boundaries of the channel. That is, the MPS server can determine the street numbers of points such as M 588 and N 590. The MPS server then determines if those matching stores from the above steps have street numbers that fall between the boundary points such as M and N. If a store does have a street number that falls between boundary points like M and N, the store is selected and is presented to the buyer, if not, the store is screened out and disregarded. For example, suppose the MPS server determines the address number of M 588 is 2002 31st Street and the address number of N 590 is 1800 31st Street, a store with street address number 1900 31st Street will be selected and a store with address 2300 31st Street is disregarded. If no store is selected, the buyer can modify channel width and commute route to perform another search. After the buyer finds those stores that carry products the buyer wants to but by using this search method, the buyer can go to the store's web site and place order. The buyer then decides whether the buyer wants to use a MPS service for pickup. If the buyer wants to, the MPS server goes to step 406 (FIG. 4) and continues the procedures as described previously.

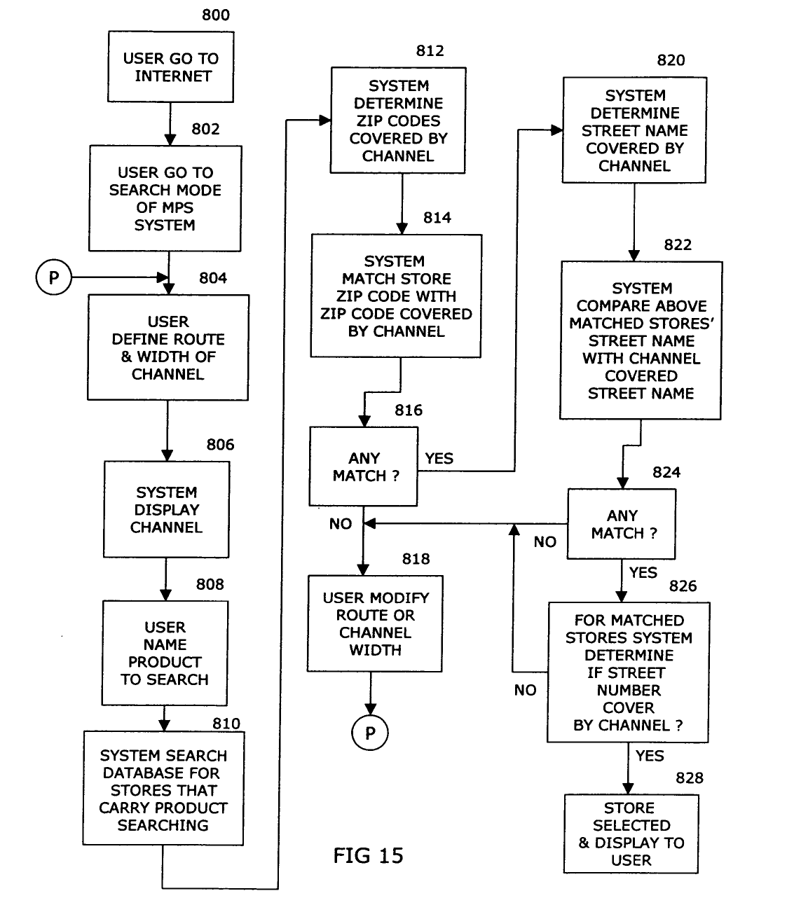

FIG. 15 is a flowchart presentation of the above search method. A buyer uses a Web browser to access a MPS server at step 800. The buyer enters a channel search mode at step 802. The buyer defines a route and a channel as previously described in step 804. The MPS server displays the channel to the buyer at step 806. The user selects a product to search for at step 808. The MPS server searches a store database for stores carrying the searched for product at step 810. The MPS server determines channel Zip codes covered by the channel as previously described at step 812. The MPS server matches the channel Zip codes found in step 812 to store Zip codes of stores found in step 810. The MPS server determines if any store Zip codes matched any channel Zip codes at step 816. If no matches were found, the buyer is invited to modify the search parameters at step 818.

If the MPS server determines that there are matches between the channel Zip codes and the store Zip codes, the MPS server determines the street names covered by the channel in step 820. The MPS server matches store street names to channel street names to determine if a store might fall within the channel at step 822. If there are no matching store street names and channel street names, the buyer is invited to redefine the search parameters at step 818.

If the MPS server determines that there are matches between the channel street names and the store street names, at step 826 the MPS server determines if a store street number is within the channel boundaries as previously described. If there is a store street number within the channel boundaries, the MPS server displays the store to the buyer at step 828. If there are no store numbers within the channel boundaries then the MPS server invites the buyer to redefine the search parameters at step 818. In one embodiment of a MPS server, the MPS server allows a third party seller to search for another third party seller within a specified territory. This method is the “Territory Search Method” referred to earlier. Referring again to FIG. 14, third party seller S8 750 uses this method to locate affiliated third party sellers S9 754 and S10 756 that are within a territory 780 of a MPS warehouse 700 that serves a buyer's 752 preferred pickup point 774. The MPS server may operate on a territorial basis, i.e. a MPS warehouse may be assigned a regional territory 780 and serve a number of pickup points 774 and 778 that are within its territory while other MPS warehouses may cover and serve other pickup points 768 within the other MPS warehouses respective territories.

When the buyer places an order with third party seller S8 and the buyer wants to use MPS services, the buyer tells third party seller S8 a pickup point ID number that is assigned and used to identify the buyer's preferred pickup point. Third party seller S8 then transmits the buyer's pickup point number along with all the addresses of its affiliates to the MPS server. The MPS server uses the transmitted buyer pickup point number to identify the MPS warehouse that serves the buyer's preferred pickup point.

In this embodiment of a MPS server, every MPS warehouse is assigned a territory. A MPS server's territory is determined by a MPS server according to criteria such as: number of buyers served, buyers' demographic distributions, distances a MPS has to travel, time a MPS spends when traveling to MPS pickup points etc. Every territory, e.g. 780, has its boundary, e.g. 782, and may be in different shapes as needed, e.g. it may be in the shape of rectangular, circle or other irregular shapes. Each point on the boundary has a known distance and relative direction to MPS warehouse; therefore the street address of each point on the boundary can be determined.

The MPS server then determines the zip codes and street names that are covered by the territory using the same method as previously described in the channeled route search method along with the affiliates' addresses provided by the third party seller S8, the MPS server may be able to identify those affiliates that are within the territory of the MPS warehouse which serves the buyer's pickup point. Using the same procedures as used in the channeled route search method, the MPS server first screens out those affiliates with zip codes not covered within the territory. The MPS server then screens out those affiliates with street names not covered by the territory. Finally, by establishing the addresses at the boundary, the MPS server may determine those affiliates with addresses that are covered by the MPS warehouse territory. The MPS server then presents these affiliates to the third party seller S8 for selection.

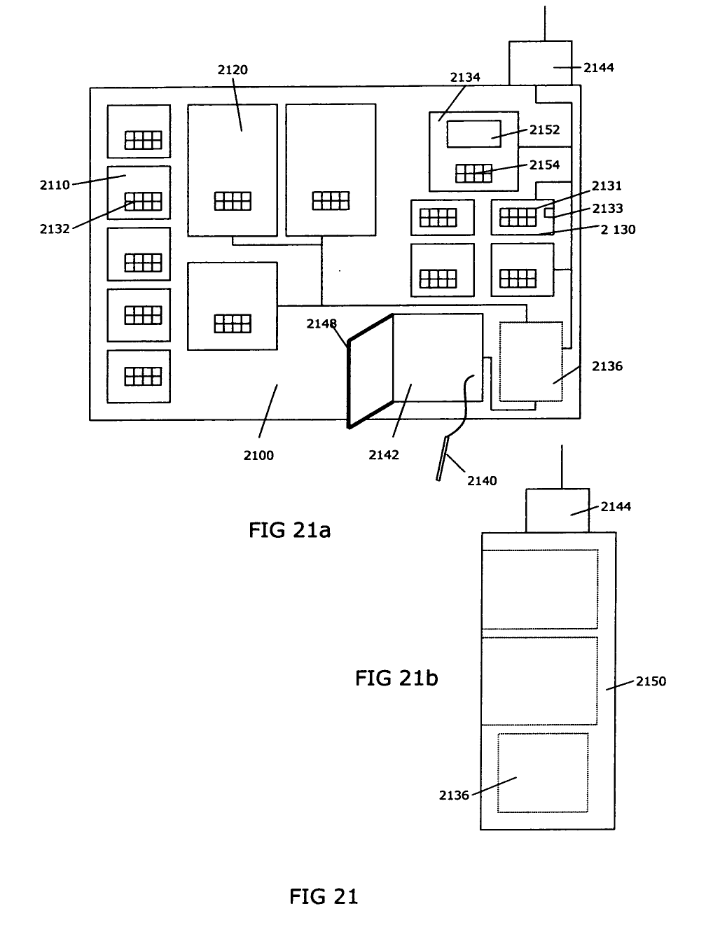

Referring now to FIG. 23, In an MPS server in accordance with an embodiment of the present invention, the MPS server is operated with multiple MPS warehouses. In this embodiment, each warehouse covers its own territory. The buyer/user goes to a MPS web site, inputs the beginning and end address to define his/her route. The user may use other information such as zip codes, telephone numbers or landmarks to define his/her route as described before. The MPS server, according to this user route information, determines the territory that serves the user. For example, route 2302 is covered by territory 2304 that is assigned to warehouse 2310. A user route my be covered by more than one territory, for example, route 2320 is covered by territory 2322 and territory 2324.

In one embodiment of a MPS server, a buyer specifies another party to pickup the buyer's products. The buyer uses a MPS server to modify the pickup point to be a place where a picking up person prefers. The buyer can also specify the name of the picking up person and request that a MPS operator check the ID of the person who picks up the product to ensure proper pickup. In the case where the MPS is a locker kiosk including a plurality of lockers, the buyer can pass the code that is used to open the locker to the receiver so that the receiver can open the locker to take the product out of the locker. In the case where the MPS server is operated by an entity that engages in the business of delivery or transportation, the service that MPS server provides is the transport of the buyer's product or packages to a pickup point the picking up person desires and waits for the picking up person to pickup.

In one embodiment of a MPS server, the MPS server establishes Fixed Pickup Stations (FPSs) which are fixed structures such as buildings or offices that have the capacity to store user orders. For example, there may be stores, e.g. gasoline stations, convenience stores or super markets . . . etc, that are located within the previously described available pickup points selection area. The MPS server may wish to contract with these stores to be pickup stations for MPS buyers. If a store agrees and an agreement is reached by the entity operating a MPS server and the store operators, the store becomes a FPS and will be one of the pickup points that are available for MPS buyers to select as pickup points. The server then displays these FPSs the same way as displays MPSs for the user's selection. After user selects the FPS the user wants his/her order to be shipped to, the MPS server arranges for products ordered by buyers to be shipped to the FPS. Each FPS station may be used as a pickup point as well as a drop off point, the same way as a regular MPS.

In another embodiment of the present invention, the FPS is equipped with temperature control equipment(s) such refrigerator, freezer and heater to store food products. In another embodiment of the present invention, the FPS is equipped with at least one cooking implement for the FPS operator to cook or prepare a user order. The server may select to equip a FPS with any one or more of the following cooking equipment(s), such as: oven, microwave oven, stove, sinks, water supply, gas supply . . . or any other cooking equipment as long as the operator may use the equipped equipment to fulfill intended cooking or preparing functions. In operation, the server displays FPS and the user selects preferred pick up point (a FPS in this case) following the same process as MPS pick up point selection as described. The server then ships the food a user ordered (fully cooked, partially cooked or uncooked) from its central kitchen to the user selected FPS. The user then picks up his/her order at the selected FPS. The FPS operator stores user food orders in the refrigerator or heater. The FPS operator may, depend upon the nature and the requirement of the order, use the cooking equipment(s) equipped to cook or prepare these partially cooked or uncooked order to its ready condition before give it to the user.

A MPS can be a receiving station as well as a drop off station. A drop off station is a station where a user submits to MPS personnel packages the user wants the MPS service to ship to a receiver. The MPS server, after receiving packages dropped off from the user ships the packages back to a MPS warehouse for distribution. After distribution, the packages may be shipped to a MPS pickup point that is convenient to the receiver's commuting route, or shipped by other means, such as shipped by a common carrier, e.g. UPS, for delivery to a receiver. In the case where a MPS server is a delivery or transportation business entity, such as FedEx, a MPS can be used as a pickup station for those designated receivers to pickup their packages. A MPS can also be used as a drop off station for those users to drop the packages they want the MPS server to ship to the packages receivers. Again, after a MPS receives such packages from the user, the MPS will ship the packages back to a MPS warehouse for distribution.

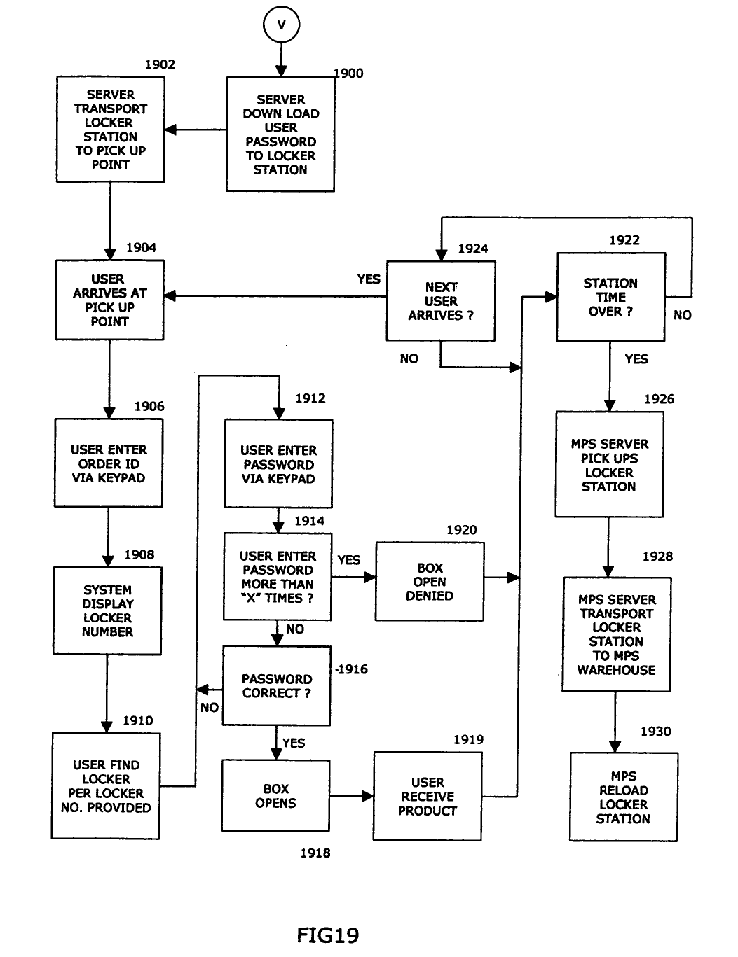

Referring now to FIG. 21a and FIG. 21b, in a MPS locker station in accordance with an embodiment of the present invention, the MPS locker station 2100 with side view 2150 includes a plurality of lockers such as lockers 2110, 2120 and 2130, which enclose products ordered by the buyers. Each locker is electrically coupled to a microprocessor or controller 2136 for operation of the locker kiosk. The controller is electrically coupled to the lockers by a keypad as exemplified by keypad 2131 and an electrically actuated lock or bolt as exemplified by electrically actuated lock 2133 of locker 2130. This locker kiosk, herein referred to as “locker station”, is portable and is transported to the assigned pick up point after the locker station is loaded with products the buyer ordered and will be stationed at the pick up point during the station time. The locker station, like other kinds of pick up stations, has the capacity to carry all kinds of products. For instance, in one embodiment of a MPS kiosk, in addition to the ability to carry general non-perishable products, the MPS kiosk is equipped with a cooling device to carry food or floral products. The cooling system, just like those installed on other pick up stations, may be a refrigerator powered by electricity or solar power. The cooling system may also be an insulating system that is cooled by ice, dry ice or other means. Those lockers 2110, 2120, 2130 installed on the locker station 2100 can be opened by using an entry code (i.e. a password) assigned temporarily to the locker and given to a buyer. Lockers may vary in size. A buyer, after completing his/her order, receives a locker identifier (e.g. a product ID) and an access code (e.g. a password) to open the locker. The buyer goes to the pick up point where the MPS locker station is positioned, and uses the identifier and access code to identify and open the locker to receive the product ordered. In one embodiment in accordance with the present invention, the locker station is secured to the ground or a wall by a lock so that it cannot be moved easily. In this way, it may not be necessary for an operator to attend to the kiosk during operation.

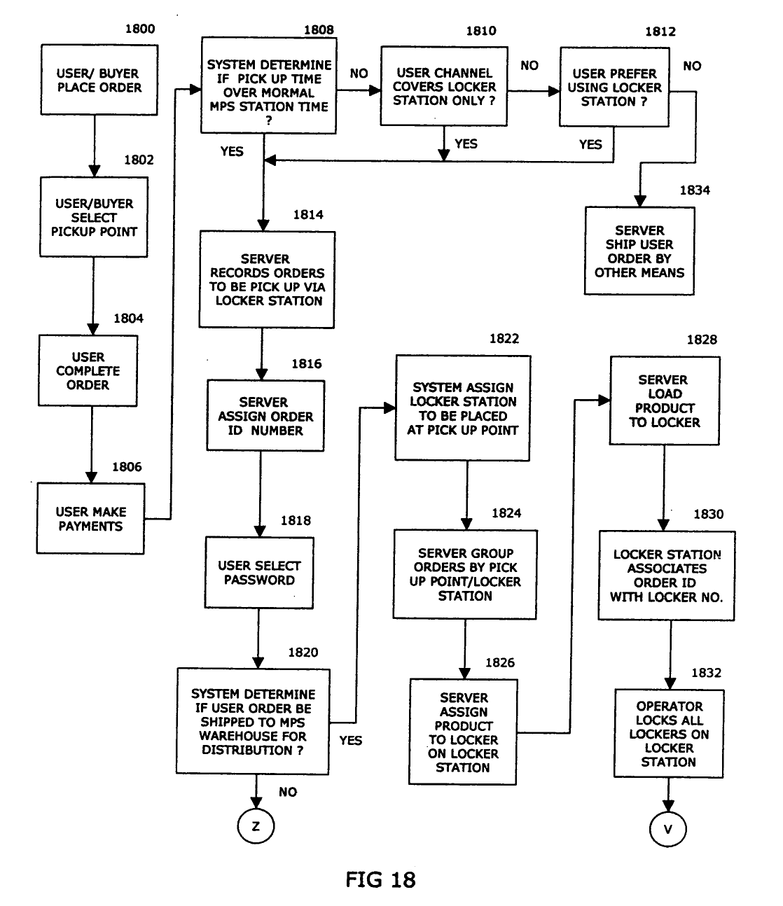

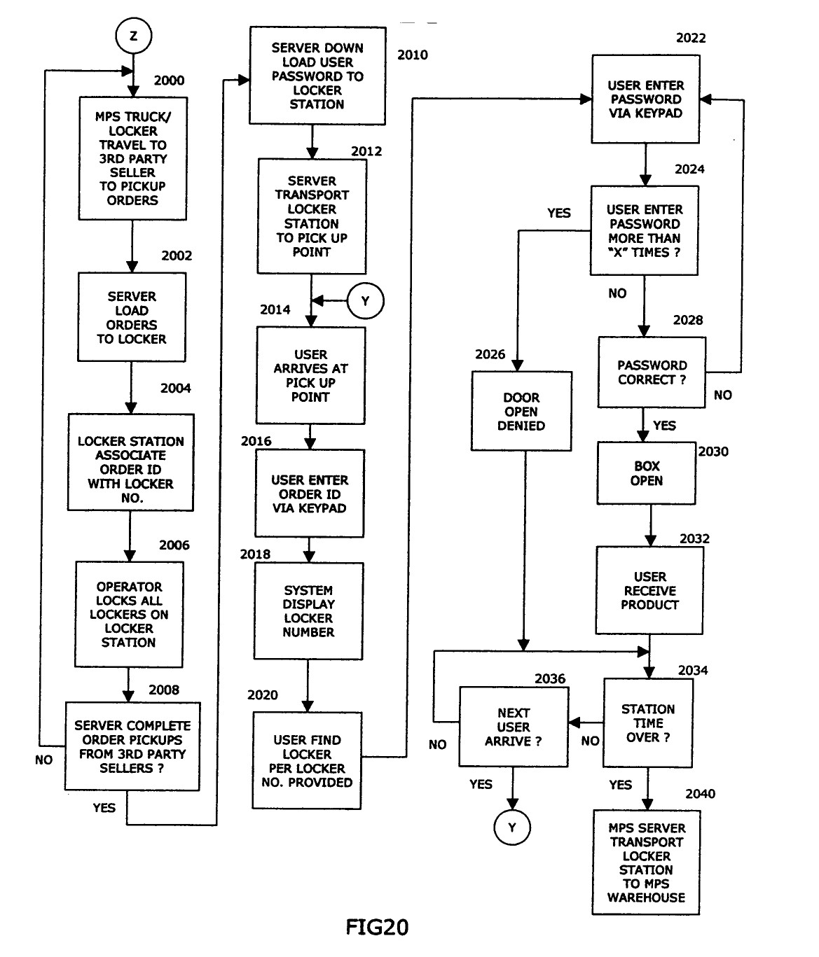

Referring now to FIG. 18, FIG. 21, and FIG. 22, a user/buyer places an order 1800 and selects his/her preferred pick up point 1802. When the user completes his/her order 1804, he/she makes payments. The payments may be made by using credit card, by using checks or by other means 1806. Steps 1800 to 1806 are similar to steps 100 to 174 of FIG. 1 as described before. The system reviews the user's entry for pick up time and determines if the user's preferred pick up time passes normal MPS station time. A locker station, because it can be operated without operator, can be assigned a station time much longer than that of a normal station that is attended by an operator. A user's order may be assigned to a locker station if the user wants to pick up order at a time that passes normal station time 1808. Also, the user may be assigned to a locker station to pick up his/her order, if his/her preferred channel covers locker station only 1810, or the user prefers to pick up at a locker station 1812. The user's order will be shipped by other means, e.g. normal MPS station . . . etc, if it is not transported by locker station 1834.

The server records those orders that will be handled by locker station 1814. The server then assigns an order identifier (an ID number) to the user for his/her order 1816. The order ID may be the seller's sales order number or other numbers defined by seller. In one embodiment, the seller may use MPS server's shipping sticker number 2202 (FIG. 22) as the order ID. MPS server uses, and sends to third party sellers for their uses, shipping stickers 2200 with bar codes 2204 that represents shipping sticker number 2202. The seller fills out necessary information on the sticker and sticks the sticker at the out side the order package. The uses of sticker will be disclosed later. The user make a record about this order ID number as he/she will use this number later to find the locker that contains his/her order. The user selects a password at step 1818.

In another embodiment in accordance with the present invention, the MPS server arranges to have user orders placed by a third party seller to be transported to MPS warehouse and then the server loads those orders to a locker station 1820. In this embodiment, the MPS server either has the third party seller ship orders to a MPS warehouse or the operator of the MPS server picks up these orders from third party sellers then ships them back to a MPS warehouse where locker stations are waiting to be loaded. The MPS server assigns each locker station a pick up point to where the locker is to be placed at 1822. The MPS server groups orders by pick up points. The operator of the MPS server then transports those orders to the locker station that will be placed at the pick up point 1824. The MPS Server then assigns each order with a locker (e.g. locker 2120 FIG. 21) to be stored in 1826. The MPS server assigns orders to lockers based upon order sizes, product character (e.g. a perishable product like food or floral product may be assigned to a locker with cooling capacity) or other criteria such as: the MPS server may place the order of a handicapped or short user at a lower locker for his/her convenience . . . etc. The operator of the MPS server then loads product into the assigned locker 1828. The MPS server then registers the product order ID with the locker so that the system may relate product order ID to its storing locker 1830. In a registration process in accordance with an embodiment of the present invention, the operator deposits user orders into a locker 2110, then the operator uses keypad 2132 (FIG. 21) on the locker to enter the product ID displayed on the product package into the locker's system. Because each locker has a keypad installed on its door and each keypad is separately wired to the microprocessor or controller 2136 of the main keypad 2134, the microprocessor can relate the product order ID to its storing locker. The microprocessor contains memory means to record the product ID entered through each keypad. In another embodiment of the registration process in accordance with the present invention, the operator can use an optical scanner pen 2140 to scan the bar code 2204 on the MPS shipping sticker 2200 (FIG. 22). The sticker is placed to the outside of the order package by the seller. Each locker has an optical scanner pen wired to its inside. FIG. 22 shows a locker 2142 with a door 2148 opened and a scanner pen 2140 wired to the inside of the locker. Each scanner pen is separately wired to the microprocessor of the main keypad. The shipping sticker contains a bar code 2204 that represents the product ID 2202. By scanning the bar code with the scanner pen, the microprocessor relates each locker with the product order ID of the product it stores. After the operator loads all the orders into lockers, the operator locks all the lockers on the locker station 1832. The operator then downloads, from the MPS server, user passwords to the locker microprocessor 1900 (FIG. 19). The locker station then registers these passwords. In one embodiment in accordance with the present invention, the down load is performed through a wiring connection from a MPS server to a locker station's microprocessor. In another embodiment, the down load is performed through a wireless radio transmission between the MPS server and the radio transmission device 2144 (FIG. 21) connected to the locker microprocessor. The operator of the MPS server then transports the locker station to its assigned pick up point 1902. The locker station stays at the pick up point. A locking device may lock and fix the station to the ground or to a wall so that it cannot be removed easily. When the user arrives at the locker station 1904, he/she keys in the order ID through the main keypad 1906 (also 2134 FIG. 21) by using keypad 2154 (FIG. 21). The microprocessor finds the locker that related to the order ID. The display device 2152 (FIG. 21) on the main keypad 2134 (FIG. 21) displays the locker number of the locker that stores user orders 1908. The user then finds the locker storing his/her order by locker number provided 1910. At step 1912, the user keys in the password by using the keypad 2132 (FIG. 21) on the locker 2110 (FIG. 21). If the password is entered correctly, the locker will open 1918, and the user receives the product in the locker 1919. If the user enters a wrong password, the system asks the user to enter it again 1912. If the user fails a certain time of password entries, the user is denied to open the locker 1920. The station stays at the pick up point for a determined station time; within this station time the station serves other users that arrive 1924. When station time is up, the operator of the MPS server recovers the locker stations 1926 and transports the locker stations back to a MPS warehouse 1928 for reloading 1930.

Referring again to step 1820 of FIG. 18, in another embodiment of a MPS system in accordance with the present invention, the MPS truck may carry locker stations and travel to third party sellers to collect user orders then goes directly to the assigned pick up point without going back to a MPS warehouse.

Referring now to FIG. 20, the MPS truck travels 2000 with lockers to third party seller to pick up user order. The MPS operator then selects a locker to store the order he/she just picked up 2002. The operator then registers order ID with locker 2004 and locks all the lockers 2006. Steps 2002 to 2006 is similar to steps 1828 to 1832 of FIG. 18 and can be understood by referring to these steps. The MPS truck/locker travels to other third party sellers to collect orders until all orders are collected 2008. The operator of the MPS sever down loads a user password through wireless radio transmission between the MPS server and the radio transmission device connected to the locker microprocessor 2010. Steps 2012 to 2036 describe the steps from locker station's arrival at pick up point to the over of station time, which are similar to steps 1904 to 1922 of FIG. 19 and previously described before and are not repeated here. At step 2040, the MPS locker station is transported back to a MPS warehouse when station time is over.

In another embodiment of locker station in accordance with the present invention, a locker station may be fixed at a pick up point as a FPS (Fixed Pickup Station) described before and cannot be moved. In this embodiment, the operator of the MPS server ships user orders to the locker station and loads the lockers with orders. The MPS server may receive user pickup information transmitted from the locker station on a regular basis so that the MPS server may monitor the activities of the locker station.

In another embodiment in accordance the present invention, the operator of a MPS server may decide not to install all lockers with keypads but instead use a main keypad to receive user key-ins and to control lockers activities. In this embodiment, the user enters order IDs into the main keypad. The main keypad then displays the locker number of the locker that stores the user order. The user then enters password into main keypad. If the password is entered correctly, the locker door will open for the user to receive his/her order. In this embodiment, the main keypad will be the only keypad installed and the operator keys in product ID together with the locker number that stores the order (unless the optical scanner pen is used). The purpose of entering product ID with locker number is to allow the locker to relate that information together.

If the user fails to pick up his/her order timely, operator of the MPS server may decide that it will ship those products back to the same pick up point for the user to pick up again. The user may not want to change password and the locker that stores the order. The operator of the MPS server may establish a policy that allows users to pick up products within a determined number of days. Beyond this predetermined period, the product may be returned to the sender or handled in a way according to the operator of the MPS server's policy.

In one embodiment in accordance with the present invention, it should be noted that a locker station can be a drop off point also. In this embodiment, the user goes to a MPS system and tells the system the size of the drop off load. If the MPS server determines that a locker will be available for receiving drop off, the system gives the user an order ID and allows the user to set up a password. The user goes to the pick up station then keys in the order ID and password into the main keypad. If the order ID and password are entered correctly, the microprocessor opens the locker and the locker is available for the user to deposit the package he/she wants to drop off. The user may post instructions on the package as how he/she wants the package to be handled. The user may give the order ID and the password to a third party receiver. The third party receiver can use the order ID and password to find and open the locker and receive the product.

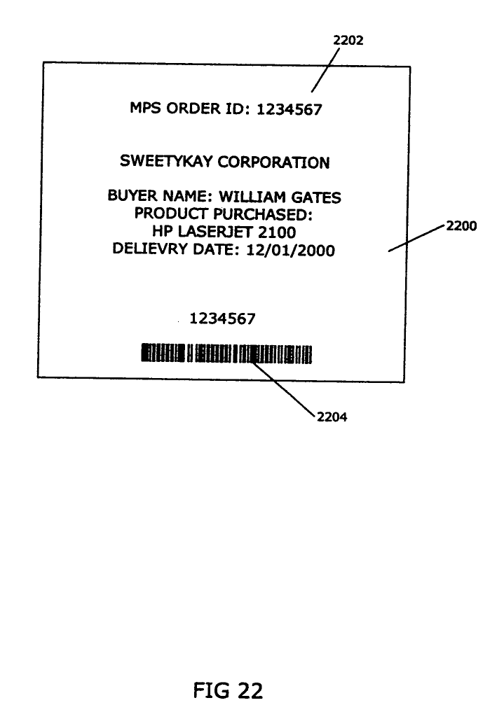

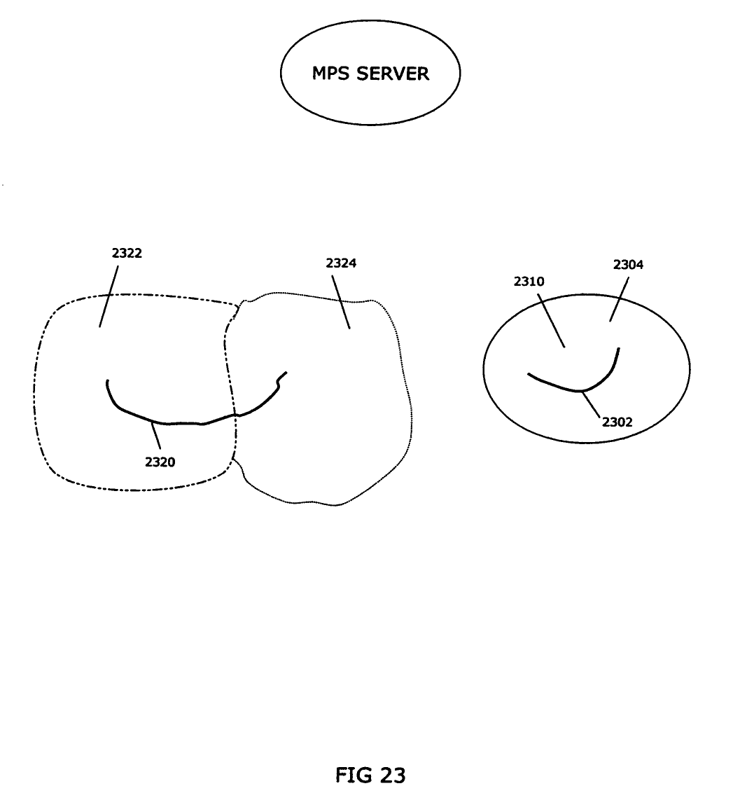

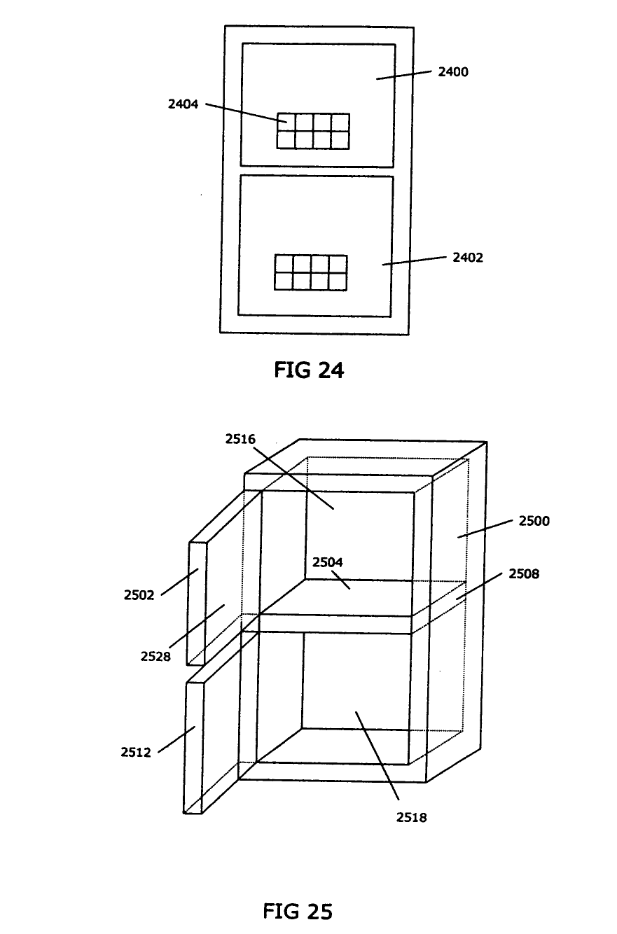

In another embodiment in accordance with the present invention, two lockers in the locker station can be adjusted to become one larger size locker. FIG. 24 shows two lockers 2400 and 2402 with keypad 2404. FIG. 25 shows the same lockers with doors 2502, 2512 opened. Divider 2504 is at its down position. When the divider 2504 is secured at this down position, the whole locker construction 2500 includes two separate lockers 2516 and 2518. A unit 2528 is shown in its up position and is hidden in door 2502. FIG. 26 shows the same locker as in FIG. 25 with divider 2604 in its up position. Unit 2610 is a bolt unit, now in its “in” position. This bolt unit is installed to secure divider 2604 to the wall when it is at its down position. Bolt unit 2608, constructed within door 2602, is shown in its down position. When doors 2602 and 2612 are lined up and bolt unit 2608 is in its down position, the bolt unit goes into a slot in the door 2612 and thereby connects door 2602 and door 2612 into one piece. Now, if the divider 2604 is at its up position, the whole construction 2600 is now one locker with lager size then before.

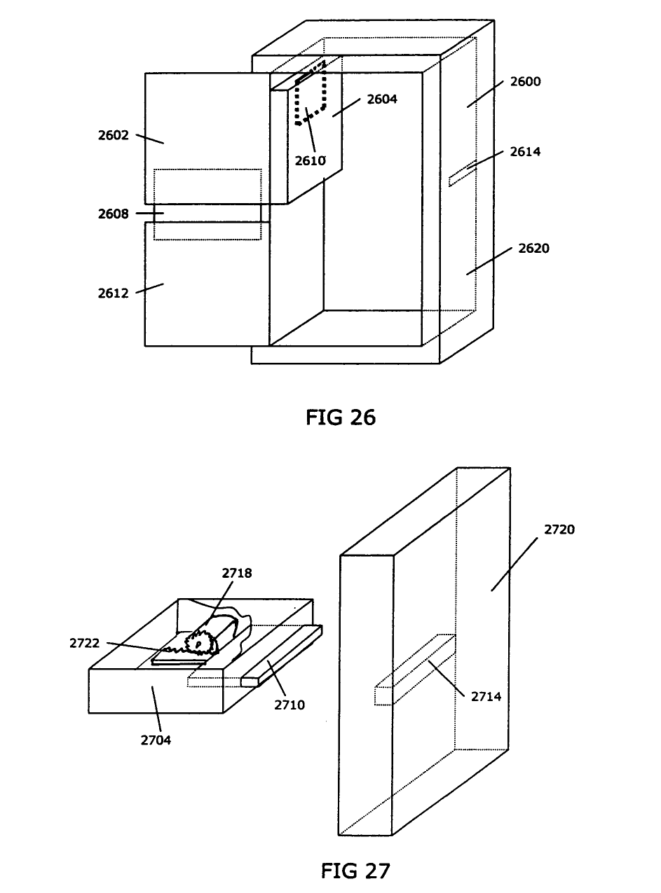

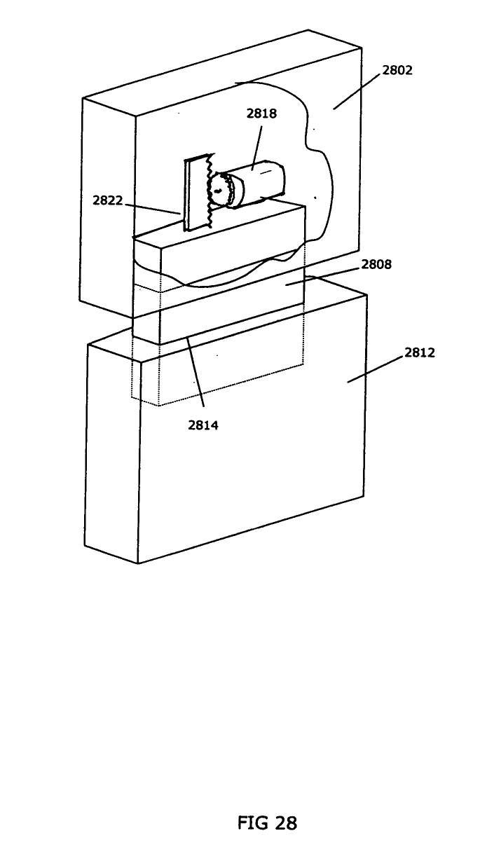

Referring now to FIG. 27, 2720 is one of the walls of locker station, and is the same as unit 2620 as shown in FIG. 26. 2714 is a slot built into wall 2720. Divider 2704, the same unit 2604 in FIG. 26, is now in its down position. Divider 2704 contains a bolt unit 2710 that can move in and out. When a MPS operator positions the divider at its down position and makes the bolt unit 2710 at its out position, the bolt unit goes into slot 2714 and makes the divider “locked” to the wall and secured at this place. The movement of bolt 2710 may be accomplished by many different means. FIG. 27 illustrates one of these means where the movement is controlled by an electric motor 2718 that is connected to the bolt by a gear unit 2722. FIG. 28 shows two doors 2802, 2812 that are the same units as doors 2602, 2612 in FIG. 26. 2808 is a bolt that can move up and down is now at its down position. When bolt 2808 goes down, it goes in to slot 2814 in door 2812 and lock door 2802 and 2812 into one piece. The movement of bolt unit 2808 can be achieved by many different means. FIG. 28 illustrates one of these means where an electric motor 2818 and gear unit 2822 control the bolt movement.

Referring again to FIG. 25, when the operator prefers to use two lockers with smaller spaces, he/she will lower divider 2504 (or 2704 FIG. 27) to its low position and switch the motor inside the divider to make the bolt go to its out position, the whole construction become two separate lockers. If the operator prefers to use one locker with a larger space, he/she can switch the bolt in the divider to its in position 2610 and raise the divider to its up position 2604. The operator then lines up those two doors, switches the bolt in the upper door to its down position 2608, and connects those two doors in one piece, creating one locker 2600 with larger space as shown in FIG. 26. The same method can be used combine three or more lockers into one big locker.

Referring again to FIG. 4, when the user/buyer goes to a third party seller's web site and purchases on line 404, he/she makes decision if he/she wants to use MPS service as a delivery method 406. If he/she does, he/she gets access to MPS system 408 to use MPS route selecting mode. In the route selecting mode, user selects routes, pick up points and selects pick up times (as covered previously from step 112 to 138, FIG. 2). There are many different ways to get access to MPS route selecting mode. In one embodiment, the user is transferred (or linked) to MPS server from the third party's web site. MPS server maintains system software that handles all the functions in the route selection mode. MPS server also maintains a data base that keeps all users' information, such as: users' preferred routes, preferred pick up points, pick up times, addresses, preferences . . . etc. The third party seller, when in need of user information or wishes to see pick up point information, route information . . . etc can log on to MPS server to get access to third party information. The MPS server collects all order information, e.g. order sizes, pick up point, pick up time, name . . . etc, from all third party sellers and arranges shipment of products to MPS warehouse and dispatches MPS stations to pick up points. Shipment information is then transmitted to the third party seller for its record. In another embodiment in accordance with the invention, the MPS server, under arrangements with the third party seller, down loads route selecting system software with/without user information to the third party's system. In this way, a user uses route selecting mode within third party's web site (system) to select route, pick up point and pick up time . . . etc. Order information and pick up information is then transmitted to the MPS server for the MPS server's use to arrange shipment when the order is completed. The MPS server constantly updates third party seller for pick up point changes, route changes, map changes . . . or other necessary changes.

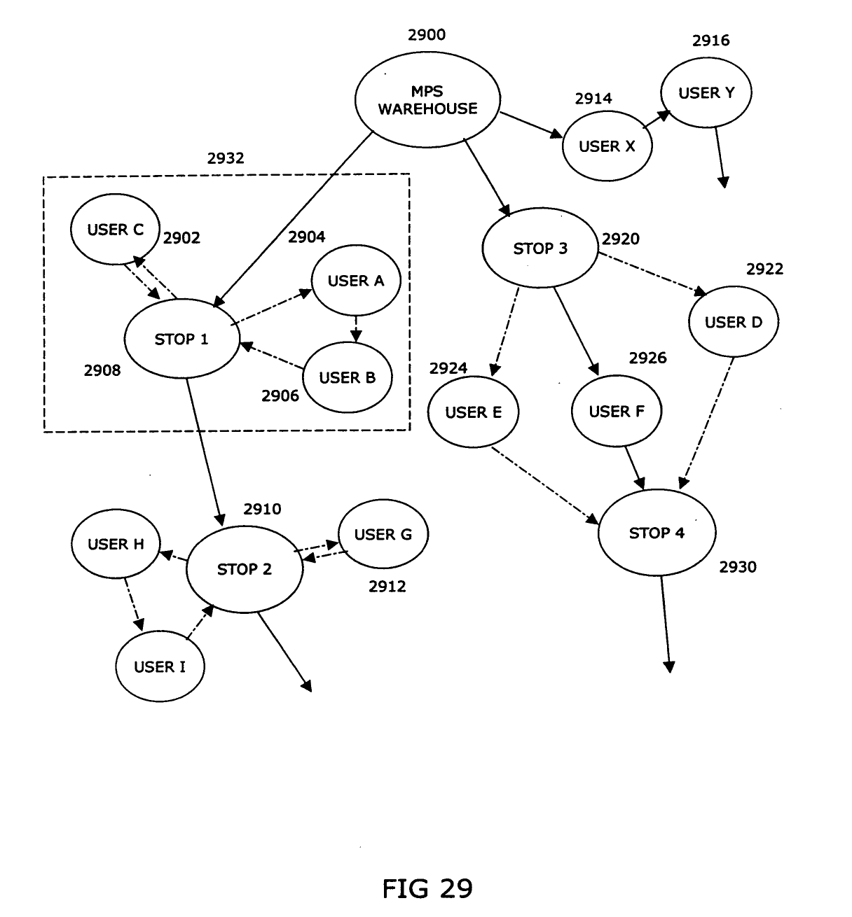

In another embodiment of the present invention, one or more Subsidiary Delivery Personnel (SDP) are involved in the delivery process to more efficiently perform delivery functions as shown in FIG. 29. In the traditional delivery model, a carrier (e.g. a delivery truck) loaded with goods leaves warehouse 2900 and travels to customer X 2914 and drops off the goods the customer ordered and moves to the next customer Y 2916 and the next customer . . . . In this traditional model, the carrier operator acts alone and covers the whole delivery route by himself. In an exemplary embodiment of a MPS system, a carrier is accompanied by (or carries) at least one Subsidiary Delivery Personnel (SDP) with it. A Subsidiary Delivery Personnel (SDP) is a person that stays with a carrier and delivers goods assigned to him to his/her customer after the carrier stops at a stop point. After the carrier (e.g. a truck or a MPS truck) leaves warehouse 2900, it stops at predetermined stop points and dispatches its SDP(s). The SDP(s), who carries the assigned delivering goods with him, delivers the goods to its customers. See FIG. 29. As an example, when the currier stops at Stop 1 2908, the carrier dispatches a SDP to deliver goods to user/customer A 2904 and to user/customer B 2906. Also the carrier dispatches another SDP to deliver goods to user/customer C 2902. The system predetermines stop points. An ideal stop point is a place where the carrier stops and can most efficiently utilize SDPs to cover a determined delivery area, such as area 2932. All SDPs return to the stop point after they deliver the goods that are assigned to them. SDPs then get on to the carrier, the carrier then travels to the next stop point (Stop 2) 2910 and repeats the cycle to complete the next delivery.

A Secondary Transportation Means (STM) may be used by a SDP to aid his/her delivery duty. A STM is a transportation device, which may be a bicycle, a motorcycle or a vehicle. The carrier is equipped with means to carry these STMs. For example, the carrier may equip racks or is hooked with a trailer to carry STMs such as bicycles. When a carrier stops at a stop point, it dispatches its SDPs. The SDP may walk to deliver his/her assigned goods or get a STM to aid him with his/her delivery. For example, a SDP may get a bicycle (a STM) to help him with a speedier delivery. The carrier itself, after dispatching its SDPs, may travel to a user/customer to deliver goods to the user. For example, the carrier may stop at Stop 3 2920, dispatches its SDPs and it itself may travel to user F 2926 to deliver goods to user F. The carrier then travels to the next stop point Stop 4 2930, and waits for its SDPs to return after they deliver their assigned goods. The SDPs are instructed previously to go to a predetermined stop point (Stop 4 2930) to meet the carrier after they complete their delivery. The carrier receives its SDPs and moves to the next stop point. The solid lines in FIG. 29 represent the movements of the carrier and the dot lines represent the movements of SDPs. The dotted line 2932 however, represents the area SDPs cover when the carrier stops at stop point 1 2908.

Having thus described several exemplary implementations of the invention, it will be apparent that various alterations and modifications can be made without departing from the inventions or the concepts discussed the herein. Such operations and modifications, though not expressly described above, are nonetheless intended and implied to be within the spirit and the scope of the inventions. Accordingly, the foregoing description is intended to be illustrative only.

What is claimed is:

1. A computer implemented method of delivering a meal to a buyer, comprising:
selecting a pickup point and a pick up time for the meal by the buyer;
transporting to the pickup point the ingredients for the meal in a mobile pickup station, the mobile pickup station including food preparation equipment; and
preparing the meal at the pickup point for delivery to the buyer at the pickup time.

2. The method of claim 1, wherein selecting a pickup point further includes:
receiving route information from the buyer;
selecting from a plurality of pickup points a pickup point based on the route information.

3. The method of claim 2, wherein selecting a pickup point further includes:
receiving a channel width from the buyer;
calculating a channel area using the channel width and the route information;
determining a set of pickup points from the plurality of pickup points based on the channel area; and
selecting by the buyer from the set of pickup points a pickup point.

4. The method of claim 3, wherein the channel width is specified as a distance from a route generated from the route information.

5. The method of claim 3, wherein the channel width is specified as a buyer preferred traveling time from a route generated from the route information.

6. The method of claim 3, wherein the channel width is specified as a traveling distance along roadways from a route generated from the route information.

7. The method of claim 2, wherein the route information includes a plurality of landmarks, the method further comprising generating a shortest travel time route between the landmarks.

8. The method of claim 2, wherein the route information includes a zip code.

9. The method of claim 2, wherein the route information includes a city name.

10. The method of claim 2, wherein the route information includes a telephone number.

11. The method of claim 1, further comprising:
compiling buyer arrival times;
generating a meal preparation schedule using the compiled buyer arrival times; and
preparing the meal in accordance with the meal preparation schedule.

12. A computer implemented method for scheduling and delivery of a product to a buyer along the buyer's commuting route, comprising:
receiving route information from the buyer;
receiving a channel width from the buyer;
calculating a channel area using the channel width and the route information;
determining a set of pickup points from the plurality of pickup points based on the channel area;
selecting by the buyer from the set of pickup points a pickup point; and
dispatching a mobile pickup station to the pickup point, the mobile pickup station containing the product for the buyer.

13. The method of claim 12, wherein the channel width is specified as a distance from a route generated from the route information.

14. The method of claim 12, wherein the channel width is specified as a buyer preferred traveling time from a route generated from the route information.

15. The method of claim 12, wherein the channel width is specified as a traveling distance along roadways from a route generated from the route information.

16. The method of claim 12, wherein the route information includes a plurality of landmarks, the method further comprising generating a shortest travel time route between the landmarks.

17. A data processing system for delivering a meal to a buyer, comprising:
a processor; and
a memory coupled to the processor, the memory having program instructions executable by the process stored therein, the program instructions including:
selecting a pickup point and a pick up time for the cooked meal by the buyer;
transporting to the pickup point the ingredients for the meal in a mobile pickup station, the mobile pickup station including food preparation equipment; and
preparing the meal at the pickup point for delivery to the buyer at the pickup time.

18. The data processing system of claim 17, wherein the program instructions for selecting a pickup point further include:
receiving route information from the buyer;
selecting from a plurality of pickup points a pickup point based on the route information.

19. The data processing system of claim 18, wherein the program instructions for selecting a pickup point further include:
receiving a channel width from the buyer;
calculating a channel area using the channel width and the route information;
determining a set of pickup points from the plurality of pickup points based on the channel area; and
selecting by the buyer from the set of pickup points a pickup point.

20. The data processing system of claim 19, wherein the channel width is specified as a distance from a route generated from the route information.

21. The data processing system of claim 19, wherein the channel width is specified as a buyer preferred traveling time from a route generated from the route information.

22. The data processing system of claim 19, wherein the channel width is specified as a traveling distance along roadways from a route generated from the route information.

23. The data processing system of claim 18, wherein the route information includes a plurality of landmarks, the program instructions further including generating a shortest travel time route between the landmarks.

24. The data processing system of claim 18, wherein the route information includes a zip code.

25. The data processing system of claim 18, wherein the route information includes a city name.

26. The data processing system of claim 18, wherein the route information includes a telephone number.

27. A data processing system for scheduling and delivery of a product to a buyer along the buyer's commuting route, comprising:
a processor; and
a memory coupled to the processor, the memory having program instructions executable by the process stored therein, the program instructions including:
receiving route information from the buyer;
receiving a channel width from the buyer;
calculating a channel area using the channel width and the route information;
determining a set of pickup points from the plurality of pickup points based on the channel area;
selecting by the buyer from the set of pickup points a pickup point; and
dispatching a mobile pickup station to the pickup point, the mobile pickup station containing the product for the buyer.

28. The data processing system of claim 27, wherein the channel width is specified as a distance from a route generated from the route information.

29. The data processing system of claim 27, wherein the channel width is specified as a buyer preferred traveling time from a route generated from the route information.

30. The data processing system of claim 27, wherein the channel width is specified as a traveling distance along roadways from a route generated from the route information.

31. The data processing system of claim 27, wherein the route information includes a plurality of landmarks, the method further comprising generating a shortest travel time commuting route between the landmarks.
